(19) United States
(12) Patent Application Publication
(10) Pub. No.: US 2006/0236146 A1
(43) Pub. Date: Oct. 19, 2006

(54) Digital system, clock signal adjusting method for digital system, recording medium recording processing program executed in the adjusting method

(75) Inventors: Eiichi Takahashi, Ibaraki (JP); Masahiro Murakawa, Ibaraki (JP); Yuji Kasai, Ibaraki (JP); Tetsuya Higuchi, Ibaraki (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: National Inst of Adv Industrial Science and Tech, Tokyo (JP)

(21) Appl. No.: 10/559,672

(22) PCT Filed: Jun. 3, 2004
(86) PCT No.: PCT/JP04/07683

§ 371 Date: Apr. 3, 2006

(30) Foreign Application Priority Data
Jun. 6, 2003 (JP) 2003162118

(51) Int. Cl. G06F 1/12

(52) U.S. Cl. 713/400

(57) ABSTRACT

A digital system (1) which performs a digital processing according to a single or a plurality of clock signals to deliver a specified basic function, and which comprises a plurality of delay elements (4) respectively inserted into a plurality of clock circuits for supplying clock signals in a digital system, and respectively constituted by circuit elements for changing delay times according to values indicated by a control signal, and a plurality of holding circuits (5) for holding a plurality of control signals to be given to a plurality of delay elements. The plurality of holding circuits have a plurality of control signal values, held by these holding circuits, changed by external devices (6-8) according to a probabilistic search method with the digital system (1) supplied with power from a variable-output-voltage power supply (14) so that the basic function of the digital system satisfies specified specifications.

### TECHNICAL FIELD

The present invention relates to a single or a plurality of digital systems that operate in synchronization with a single or a plurality of clock signals, a method for adjusting a timing of the digital system clock signal, and a recording medium recorded with a processing program executed in the adjustment method.

In particular, the present invention is very effective in cases in which the number of digital circuit elements that are the elements constituting a digital system is very large and, moreover, the supply voltage is lower than usual, or in cases in which the supply voltage can be made higher than usual.

### BACKGROUND ART

A digital system is usually comprised of three types of logic elements constituted by AND, OR and NOT elements, and recording elements termed flipflops that store the two states (1 bit) True and False.

The most general flipflops consist of three terminals that are each of input and output terminals and a clock terminal. As well, the flipflops have the function of copying a digital signal of the input terminal and sending the copied signal to the output terminal when a digital signal that is given to the clock terminal and called a clock signal is arising and the function of keeping the digital values until the next clock signal is arising.

Generally, a digital system that operates in accordance with a limited number of clock signals is called a synchronous circuit. The time differences at which clock signals reach the clock terminal of each of the flipflops of the synchronous circuit affect the overall operation. This clock signal time difference is called clock skew.

Even with a time deviation that is the same 1 ns, for example, in the case of a clock frequency of 10 Mhz, that is, with respect to a 1% deviation in the case of a clock cycle of 100 ns, in the case of a clock frequency of 100 Mhz, that is, in the case of clock cycle of 10 ns is a 10% deviation, requiring correction. That is, as the clock frequency increases, there is a need for precision timing adjustment technology.

There are two conventional measures for countering clock skew in a digital system, which are:

(1) A countermeasure method in which, when designing a digital system, the designer performs manual adjustment to make clock skew as small as possible.

(2) The countermeasure method of inserting into the clock signal line in a digital system, an adjustment circuit that decreases the clock skew.

### DISCLOSURE OF THE INVENTION

Problems the Invention is Attempting to Solve:

However, countermeasure (1) does not solve the following problem. That is, there are variations in the characteristics of each of the elements of an electronic circuit such as transistors, resistances and capacitors, and the variations in the elements do not show up until the system is actually fabricated. This is something that is particularly evident in the elements of integrated circuits.

Therefore, because of the inability to completely ascertain these variations during the designing, a technique has been used comprising design and fabrication in which a certain range of variation is allowed, or repeatedly making prototypes and measuring actual variations.

However, this method clearly has limitations, making it impossible to utilize to the full the properties possessed by elements. This problem of variation has the strongest effect on clock skew, and this determines the operating frequency of a digital synchronous system.

Another problem point is, with respect to manual adjustment, the limitation on the scale of the circuit that can be handled. Overall adjustment with respect to a large-scale digital system such as a computer system is, as a practical problem, impossible. Also, when handling a large problem, the conventional means of dividing it into partial problems is undesirable, in that it limits the range of adjustment.

The problem point of countermeasure (2) is that adjustment is possible only in the direction of decreasing clock skew.

In actual digital synchronous systems, there is a design technique of intentionally shifting the timing of clock signals, but countermeasure (2) cannot be applied to a system design having that type of exceptional timing.

The above digital system has the following two characteristics when manufactured as an integrated circuit.

The first is that internal modification of the integrated circuit is not possible; everything has to be set during the designing. Consequently, unless a novel method is used, such as that of the present invention described below, it is not possible to adjust the timing after an integrated circuit chip has been fabricated.

The second is that due to the large variations in the elements in the integrated circuit chip, the changes that are to be made to element parameters (values of resistances and capacitors and the like, and transistor characteristics) cannot be known until after the fabrication. Thus, a novel method such as that of the present invention described below is essential in cases where elements are required to have accurate parameter values.

When a digital system is hardware design data or a general hardware design data library that is an Intellectual Property (referred to as IP) object and is intended for use by third parties, there are cases in which the functions and interface specifications thereof are publicly disclosed but information on the internal structure, from equivalent circuits onwards, is not disclosed.

When high clock frequency integrated circuits use such IP, precision timing adjustment that extends to the inside of the IP object is essential, but based on the above rights, the inside often is a black box, in which case a novel method, such as that of the present invention described below, is essential for fabricating integrated circuits that operate at high clock frequencies while maintaining those rights.

Most current digital systems use CMOS technology. When a digital system is constituted using CMOS technology, a large electric power supply current flows when a digital signal changes from “0” to “1”, or from “1” to “0”.

As such, if a large number of digital signals change at the same time, momentarily there will be a large flow of electric current, and if the electric power supply capacity is not large enough, the supply voltage may fluctuate and cause malfunction.

Moreover, when there is a momentary large flow of electric current, more electric power is consumed than when there is a constant flow of a small current, necessitating the provision of a large capacity electric power supply and power supply line, increasing the size of the digital system.

The effect of simultaneously changing the digital signals can be reduced by making fine adjustments to the timing of each signal, that is, to the timing of each flipflop within the range in which overall operation takes place without error. However, a novel method, such as that of the present invention described below, is essential for such precision timing adjustment.

In addition, extraneous electromagnetic radiation (EMI) generated by a digital system should be suppressed, since it can cause malfunction and the like in other digital systems in the vicinity. EMI is generated when digital systems change from “0” to “1” or from “1” to “0”, and EMI having a large peak power is generated when many digital systems all change at once.

One means of suppressing this is a method of reducing the simultaneous changing of digital signals, that is, the simultaneous changing of flipflops. However, a novel method, such as that of the present invention described below, is essential for such precision overall timing of the flipflops of a digital system within the range in which the overall digital system operates without error.

Moreover, in the case of low electric power consumption systems including mobile telephones and other such digital systems that operate at a low supply voltage, the slow operating speed of the constituent logic elements of a system can easily give rise to disorders due to faulty timing. Such systems can be made to operate stably at a low supply voltage by adjusting the timing to achieve normal operation when using a supply voltage that is lower than usual, thereby enabling the power consumption of the digital system to be reduced.

Also, in some cases a digital system may not operate at a normal supply voltage due to large variations in its elements, but will operate normally if timing adjustment is carried out using a supply voltage that is higher than usual. Since, therefore, such systems can be made usable by adjusting the timing to achieve normal operation when using a supply voltage that is higher than usual, this makes it possible to raise the digital system production yield.

For the above reasons, there is a need for a new method of automatically adjusting the timing of clock signals of individual digital systems with the supply voltage differed from the usual supply voltage. The present invention was accomplished to advantageously solve the problems concerned.

Means for Solving the Problems, and Operation and Effect Thereof:

The digital system of the present invention, described in claim 1, attains the above object in a digital system that carries out digital processing in accordance with a single or a plurality of digital clock signals to perform a prescribed basic function, wherein the digital system is provided therein with a plurality of delay elements each comprising a circuit element that changes a delay time according to a value indicated by a control signal and is inserted in each of a plurality of clock circuits that supply the clock signals, and a plurality of holding circuits that hold a plurality of control signals applied to the plurality of delay elements, characterized in that in a state in which the digital system is supplied with power from a variable output voltage power supply apparatus, values of the plurality of control signals held by the plurality of holding circuits are changed by an external apparatus in accordance with a probabilistic search technique so that a basic function of the digital system satisfies prescribed specifications.

Also, in a digital system clock signal adjustment method of the present invention, described in claim 14, a method of adjusting clock signal timing of a digital system that carries out digital processing in accordance with a single or a plurality of digital clock signals to perform a prescribed basic function, interposing each of a plurality of delay elements into a plurality of clock circuits that supply the clock signals in the digital system, constituting each of the plurality of delay elements by a circuit element that changes a delay time according to a value indicated by a control signal, holding a plurality of control signals applied to the plurality of delay elements in a plurality of holding circuits provided in the digital system, characterized in that in a state in which the digital system is supplied with power from a variable output voltage power supply apparatus, values of the plurality of control signals held by the plurality of holding circuits are changed by an external apparatus in accordance with a probabilistic search technique so that a basic function of the digital system satisfies prescribed specifications.

In the digital system and digital system clock signal adjustment method, a plurality of control signals held by a plurality of holding circuits are applied to a plurality of delay elements constituted by circuit elements in which delay times are changed according to values indicated by control signals and which are inserted in a plurality of clock circuits that supply a single or a plurality of clock signals, wherein, in accordance with values indicated by the control signals, the delay elements each supply a basic circuit with a clock signal having an appropriate delay. Also, in a state in which the digital system is supplied with a power supply from a variable output voltage power supply apparatus, values of the plurality of control signals held by the plurality of holding circuits are changed by an external apparatus in accordance with a probabilistic search technique so that a basic function of the digital system satisfies prescribed specifications. Moreover, in the present invention, in addition to a positive delay, that is, a retardation, “delay” includes a negative delay, that is, an advancement.

Thus, in accordance with the digital system of the present invention and the digital system clock signal adjustment method of the present invention, even in cases where the characteristics of the circuit elements relating to the above prescribed basic functions cannot be accurately ascertained, in cases where the manufacturing process gives rise to error in the circuit element characteristics, in cases in which error arises from uneven quality of clock signal lines or from the design, and in cases in which the constitution of the basic circuits in a digital system is unclear due to a black box implementation such as with IP as described above, it is possible to carry out adjustments whereby clock signal timing errors are absorbed so that the digital system operates without error. Using less design labor than in the case of the conventional technology, with respect to the basic functions thereof this makes it possible to obtain higher function and higher performance than in cases based on conventional technology, makes it possible to obtain digital systems that are larger and faster than in cases based on conventional technology, and also makes it possible to improve the deterioration in digital system function and performance caused by variations in circuit elements and the like.

Also in accordance with the digital system of the present invention and the digital system clock signal adjustment method of the present invention, within the range in which the overall digital system operates without error, the overall flip-flop timing of the digital system can be precisely adjusted to slightly offset the operation timing between flipflops, thereby making it possible to prevent the size of the digital system being increased by the increase in electric power consumption, and the generation of extraneous electromagnetic radiation (EMI), caused by the simultaneous changing of digital signals.

In accordance with the digital system of the present invention and the digital system clock signal adjustment method of the present invention, moreover, in a state in which the digital system is supplied with power from a variable output voltage power supply apparatus, the values of a plurality of control signals held by a plurality of holding circuits are changed so that, as described in claim 5 and claim 18, stable operation at a low supply voltage can be achieved by performing the timing adjustment to effect normal operation at a supply voltage that is lower than usual, making it possible to reduce the power consumption of the digital system. Also, normal operation of a digital system that does not operate at a normal supply voltage due to large variations in its elements can be achieved by adjusting the timing while using a supply voltage that is higher than usual, whereby the system is usable if a high supply voltage is used, making it possible to raise the digital system production yield.

Here, the extent to which a digital system operates without error can be represented by an evaluation function F using the delay values of all adjustable delay elements as parameters. Having a digital system operate without error is equivalent to finding the solution to the above evaluation function F. Focusing on this point; the present applicants found that it was possible to apply genetic algorithms to adjust clock timing in a digital system.

Genetic algorithms are one probabilistic search technique and are algorithms that, (1) act effectively in wide-area searches, (2) do not require differential values or other derived information outside the evaluation function F, and also (3) can be readily implemented. In the present invention, therefore, as described in claims 2 and 15, a genetic algorithm can be used to change the plurality of control signals with the external apparatus.

In recent years, there is also known genetic programming in which genetic algorithms are devised to handle tree structure chromosomes. In the present invention, therefore, in cases where clock signal lines have a tree structure, genetic programming may be used to change a plurality of control signals with an external apparatus, as described in claim 3 and claim 16.

Also in the present invention, as described in claim 4 and claim 17, the changing of the control signals with the external apparatus can be done while changing the output voltage of the electric power supply apparatus in steps, that is, while processing or elevating the output voltage, making it possible to operate the digital system at a lower supply voltage or at a minimally-increased supply voltage.

The digital system of the present invention described in claim 6 is characterized in that instead of the external apparatus used in the digital system of claim 1, the digital system itself provides the setting apparatus, and the digital system clock signal adjustment method of the present invention described in claim 19 is characterized in that instead of the external apparatus used in the digital system clock signal adjustment method of claim 14, the digital system itself provides the setting apparatus.

In accordance with the digital system of the present invention and the digital system clock signal adjustment method of the present invention, an effect can be obtained similar to that of the previous digital system and digital system clock signal adjustment method. Moreover, since setting means possessed by the digital system itself are used in place of the external apparatus, it provides the additional effect that, except on the point of the electric power supply apparatus, the digital system can be used independently at a desired place at any time to carry out adjustments.

In the digital system and digital system clock signal adjustment method of the present invention, as described in claim 7 and claim 20, a genetic algorithm may be used for the changing of the plurality of control signals with the external apparatus.

In the digital system and digital system clock signal adjustment method of the present invention, also, as described in claim 8 and claim 21, genetic programming may be used for changing the plurality of control signals with the external apparatus.

In the digital system and digital system clock signal adjustment method of the present invention, moreover, as described in claim 10 and claim 23, changing the control signals with the setting means may be done with the output voltage of the electric power supply apparatus lower than the design supply voltage of the digital system, and as described in claim 9 and claim 22, changing the control signals with the setting means may be done while changing the output voltage of the power supply apparatus in steps.

The aforementioned digital system of the present invention and of the digital system clock signal adjustment method of the present invention, moreover, as described in claim 11 and claim 24, may be provided with a variable output voltage power supply apparatus which, except on the point of the electric power supply apparatus, thereby enables the digital system to be used independently at a desired place at any time to carry out adjustments.

The aforementioned digital system of the present invention and of the digital system clock signal adjustment method of the present invention, moreover, as described in claim 12 and claim 25, may be configured as an integrated circuit, thereby enabling optimal adjustment of clock signals with respect to integrated circuits in which the variations in circuit elements are not clear until actual fabrication.

The aforementioned digital system of the present invention and of the digital system clock signal adjustment method of the present invention, moreover, as described in claim 13 and claim 26, may be configured as a circuit board, thereby enabling adjustments that absorb deviations in clock timing caused by design error or non-uniformity in clock signal line processes in the digital circuit board manufacturing procedure so that the digital circuit board does not malfunction.

The aforementioned electric power supply apparatus and setting means of the present invention and of the digital system clock signal adjustment method of the present invention, as described in claim 27 and claim 28, may be configured as a computer such as a personal computer or microcomputer or the like, enabling the processing for changing the values of a plurality of control signals held by a plurality of holding circuits in accordance with a probabilistic search technique so that the basic functions of the digital system satisfy prescribed specifications to be readily and securely performed in a short time.

Furthermore, the recording medium of the present invention described in claim 29 is characterized in that it is recorded with a processing program executed by the computer in the method of adjusting clock signal timing of a digital system according to claim 27 or claim 28 for changing the values of the plurality of control signals held by the plurality of holding circuits in accordance with a probabilistic search technique so that the basic function of the digital system satisfies the prescribed specification.

In accordance with this recording medium, the processing program the computer executes for the digital system of the present invention and the digital system clock signal adjustment method of the present invention can be recorded and stored and clock signal adjustment performed at a desired place. As the recording medium, there may be used data recording media such as flexible disks, hard disks, CD-ROM and optical disks and the like, or recording elements such as ROM and RAM and the like.

### BRIEF DESCRIPTION OF DRAWINGS

FIG. 1 is a schematic diagram showing a first embodiment of the digital system of the present invention applied to a typical digital system.

FIG. 2 is an explanatory diagram showing the relationship between digital system supply voltage and operation delay.

FIG. 3 is an explanatory diagram showing the effect of adjusting the delay setting of delay elements in a digital system.

FIG. 4 is a schematic diagram showing an example of a configuration of the adjustment apparatus in the above embodiment.

FIG. 5 is a schematic diagram showing an example of the configuration of the digital signal observation apparatus in the above embodiment.

FIG. 6 is a schematic diagram showing an example of the configuration of the digital test signal generation apparatus in the above embodiment.

FIG. 7 is a schematic diagram showing an example of the configuration of the electric power supply apparatus in the above embodiment.

FIG. 8 is a circuit diagram showing an example of the configuration of an adjustable delay element used in the above embodiment.

FIG. 9 is an explanatory diagram showing the waveforms of an input signal to a NOT element and an output signal from the NOT element in the circuit shown in FIG. 8.

FIG. 10 is a circuit diagram showing an example of another configuration of a delay element used in the above embodiment.

FIG. 11 is a circuit diagram showing an example of yet another configuration of a delay element used in the above embodiment.

FIG. 12 is a circuit diagram showing an example of yet another configuration of a delay element used in the above embodiment.

FIG. 13 is a circuit diagram showing an example of yet another configuration of a delay element used in the above embodiment.

FIG. 14 is a circuit diagram showing an example of yet another configuration of a delay element used in the above embodiment.

FIG. 15 is a schematic diagram showing an example of a configuration of an adjustable delay circuit that generates positive and negative delays used in the above embodiment.

FIG. 16 is a schematic diagram showing an example of a configuration of an adjustable delay element used in the circuit shown in FIG. 15.

FIG. 17 is a circuit diagram showing an example of a configuration in the above embodiment that includes an adjustable delay element and a least significant bit register.

FIG. 18 is a circuit diagram showing another example of a configuration in the above embodiment that includes an adjustable delay element and a least significant bit register.

FIG. 19 is a flowchart showing an overview of the processing sequence in a first embodiment of the digital system clock signal adjustment method of the present invention.

FIG. 20 is a flowchart showing an overview of the sequence of a typical genetic algorithm.

FIG. 21 is an explanatory diagram showing an example of a chromosome used in a genetic algorithm.

FIG. 22 is a flowchart showing the processing sequence of an adjustment apparatus using a genetic algorithm in the method of the above embodiment.

FIG. 23 is an explanatory diagram showing a chromosome used in a genetic algorithm, the register values set thereby and the delay values, in the method of the above embodiment.

FIG. 24 is a flowchart showing the sequence of the selection process performed by the genetic algorithm in the method of the above embodiment.

FIG. 25 is an explanatory diagram showing the sequence of the crossover process performed by the genetic algorithm in the method of the above embodiment.

FIG. 26 is an explanatory diagram showing the sequence of the mutation process performed by the genetic algorithm in the method of the above embodiment.

FIG. 27 is a flowchart showing the processing sequence when adjustment is performed while lowering the supply voltage in steps in the method of the above embodiment.

FIG. 28 is a schematic diagram showing an example of a variation of the above embodiment.

FIG. 29 is a schematic diagram showing a memory test pattern generator circuit as a second embodiment of the digital system of the present invention.

FIG. 30 is an explanatory diagram showing the relationship between fitness and number of generations during testing in the above embodiment.

FIG. 31 is a schematic diagram showing an example of a variation of the above embodiment.

FIG. 32 is a schematic diagram showing a digital circuit board as a third embodiment of the digital system of the present invention.

FIG. 33 is a schematic diagram showing a digital circuit board as a fourth embodiment of the digital system of the present invention.

FIG. 34 is an explanatory diagram showing a chromosome used in a genetic algorithm, the register values set thereby and the delay value, in the method of the above embodiment.

FIG. 35 is an explanatory diagram showing the sequence of the crossover process performed by the genetic algorithm in the method of the above embodiment.

FIG. 36 is an explanatory diagram showing the sequence of the mutation process performed by the genetic algorithm in the method of the above embodiment.

### EXPLANATION OF SYMBOLS

1 Digital system
2 Flipflop that is adjusted
3 Flipflop that is not adjusted
4 Adjustable delay element
5 Register
6 Adjustment apparatus
7 Digital signal observation apparatus
8 Digital test signal generation apparatus
9 Clock signal
10 Test signal
11 Digital output signal
12 Digital system internal state signal
14 Electric power supply apparatus
93 Delay setting signal
98 Electric power supply control signal
99 Electric power supply (line)

### BEST MODE FOR CARRYING OUT THE INVENTION

There follows a detailed description of embodiments of modes for carrying out the present invention, based on the drawings.

The present invention can be applied to various digital systems that operate using a single or a plurality of digital signals. That is, in accordance with the present invention, clock signals can be adjusted by providing a plurality of timing adjustment locations in the clock circuitry of a digital system subject to adjustment. Also, the present invention uses a variable output voltage power supply apparatus only during adjustment.

The following first embodiment is described with respect to case in which the present invention is applied to a general digital system that operates using a single or a plurality of digital signals.

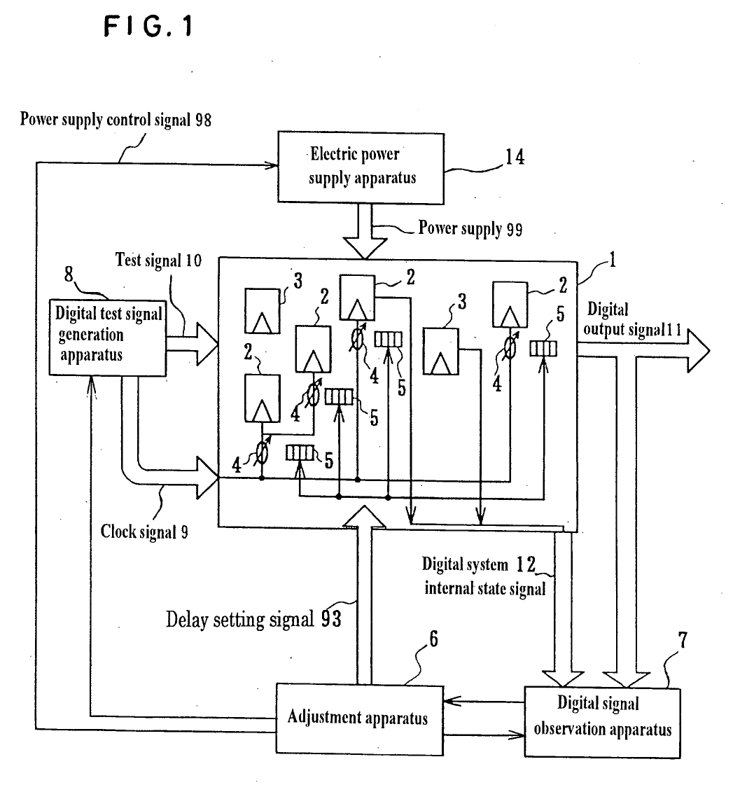

Here, FIG. 1 is a schematic diagram showing the first embodiment of the digital system of the present invention applied to a typical digital system.

The problem of digital system clock skew (disorders caused by faulty timing of clock signals) protracts the digital system design phase and limits the performance of the elements constituting the digital system, thereby limiting the performance of the digital system and making it difficult to control costs. Particularly in the case of low electric power consumption systems including mobile telephones and other such digital systems that operate at a low supply voltage, the slow operating speed of the constituent logic elements of a system can easily give rise to disorders due to faulty timing.

Therefore the digital system clock signal adjustment method of the present invention, which adjusts the clock signal timing of the individual digital systems based on the low supply voltage, is essential, and is especially important for low electric power consumption systems.

In FIG. 1, symbol 1 denotes a digital system constituted by, for example, a microcomputer or the like that, based on a provided program, performs prescribed basic functions such as data processing and the like, 2 denotes a flipflop needed for adjusting the timing of a clock signal, and 3 denotes a flipflop not needed for timing adjustment. Also, 4 denotes an adjustable delay element used to change clock timing according to register values, and 5 denotes a register that holds a delay setting of the adjustable delay element 4.

The adjustable delay element 4 is inserted between the clock terminal of a flipflop 2 and the clock line that supplies the clock signal to the clock terminal. The register 5 is connected to the adjustable delay element 4 and changes the delay value of the adjustable delay element 4.

The flipflop 2 that is adjusted and the flipflop 3 that is not adjusted (does not require adjustment) are constituent elements of the above digital system 1.

In FIG. 1, symbol 7 is an observation apparatus for observing digital output signals of digital system 1 and the internal state of the digital system 1, and 8 is an apparatus that generates test signals and clock signals for adjusting the digital system 1 in accordance with the method of the present invention.

Symbol 6 is an adjustment apparatus that is connected to the digital test signal generation apparatus 8 and initiates signal generation to the digital test signal generation apparatus 8 with respect to digital system 1 and at the same time is connected to the digital signal observation apparatus 7 and, as described below, observes digital output signal 11 of the digital system 1 to the digital signal observation apparatus 7 and digital system internal state signal 12 that shows the internal state of the digital system 1, and 14 is an electric power supply apparatus.

The adjustment apparatus 6 calculates the delay time of the adjustable delay element 4 in accordance with the adjustment method of the present invention, and writes the delay value into the register 5.

In addition, in this embodiment, the adjustment apparatus 6, digital signal observation apparatus 7, digital test signal generation apparatus 8 and electric power supply apparatus 14 are external apparatuses. Here, the electric power supply apparatus 14 supplies electric power to the digital system 1 via a power supply (line) 99. The output voltage of the electric power supply apparatus 14 can be controlled by a power supply control signal 98, and the adjustment apparatus 6 controls that output voltage.

The digital system 1 in this embodiment may be configured as an integrated circuit or as a circuit board.

Moreover, the digital system 1 in this embodiment may be configured as a single system or as a plurality of systems.

Moreover, the digital system 1 in this embodiment may be configured as a plurality of systems and include an internal communication channel, or configured as a single system and include an internal communication channel in the form of a bus.

Moreover, the digital system 1 in this embodiment may be configured as a multichip module or hybrid integrated circuit.

Moreover, the electric power supply apparatus 14 may be incorporated in the digital system 1, in which case the output voltage of the incorporated power supply apparatus 14 can be varied by the electric power supply control signal 98.

Moreover, the digital system 1 in this embodiment may be configured as IP (an Intellectual Property object and also hardware design data for third party use) or as a hardware library.

The flipflop 2 that is adjusted and the flipflop 3 that is not adjusted are recording circuits and the like comprised of ordinary D flipflops, T flipflops, SR flipflop or JK flipflops, or Earl gate circuits, registers and other recording elements that store a state according to a clock signal, or combinational circuits in a loop, functioning as the constituent elements of the digital system 1.

That is, in the digital system 1, the flipflops 2 that are adjusted and the flipflops 3 that are not adjusted are appropriately connected into combinational circuits in the digital system 1 and store internal states in accordance with the clock signals.

In the above system, the flipflops 2 that are adjusted are flipflops that are adjusted by the method of the present invention, and the flipflops 3 that are not adjusted are flipflops that are not adjusted by the method of the present invention. The adjustment can be done by other methods, such as for example timing adjustment based on simulation results obtained when designing the digital system 1, or timing adjustment based on prototype results, or timing adjustment inserted in fixed value delay element data paths or clock lines, or other such conventional techniques.

The clock delay time of a flipflop 2 that is adjusted is the delay time added by an adjustable delay element 4 inserted between the clock terminal of the flip-flop 2 and the clock line, which, compared to when an adjustable delay element 4 is not inserted, delays by the amount of that delay time the timing of a clock signal supplied to the clock terminal of the flipflop 2 that is adjusted.

The configuration of the digital system 1 subject to adjustment is provided with the aforementioned flipflops 2 that are adjusted and flipflops 3 that are not adjusted, and in this embodiment, after the digital system 1 is manufactured, the digital system 1 can be operated without error at the supplied specified supply voltage by the delay times of the flipflops 2 that are adjusted, that is, by finely adjusting the delay setting times of the adjustable delay elements 4 connected to the clock terminal of the flipflops 2 that are adjusted. Particularly in the case of systems which operate in a high supply voltage state that are unable to operate on a low supply voltage, the operating speed of the logic elements constituting the digital system are slowed by a low voltage, often giving rise to faulty timing.

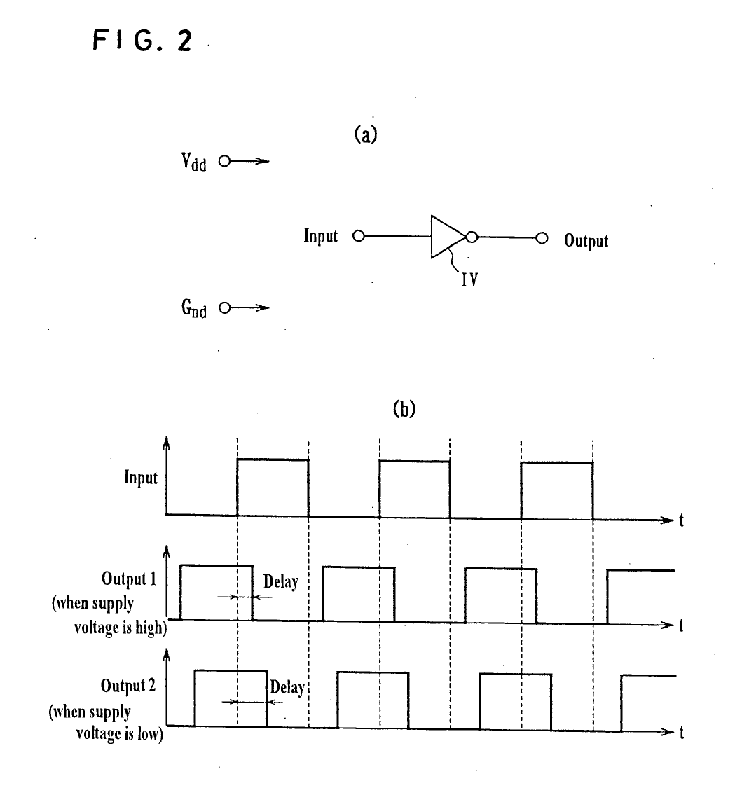

The time it takes for an input data change to be manifested at the output terminal of inverter IV, shown in FIG. 2 (a), that is one of the logic elements constituting the digital system, changes depending on the signal height of the supply voltage (shown in the figure as Vdd), as shown in FIG. 2 (b). That is, the higher the supply voltage, the shorter the time it takes to appear at the output terminal (output 1), and the lower it is, the longer the time (output 2). Therefore, operation can be effected even at a low supply voltage by carrying out the above clock timing adjustment at the low supply voltage. In addition, digital systems that do not operate even under a high supply voltage due to slightly faulty timing can be made to operate at a low supply voltage by performing the clock timing adjustment at the low supply voltage.

Using a similar arrangement, in the case of a digital system that does not operate even when the clock timing has been adjusted at the normal supply voltage, by slightly raising the supply voltage, which slightly increases the operating speed of the constituent logic elements of the digital system and increases the timing leeway, and adjusting the clock timing at that supply voltage, it is possible to improve the yield by increasing the supply voltage by just the minimum amount required, thereby also making it possible to reduce the cost of the digital system.

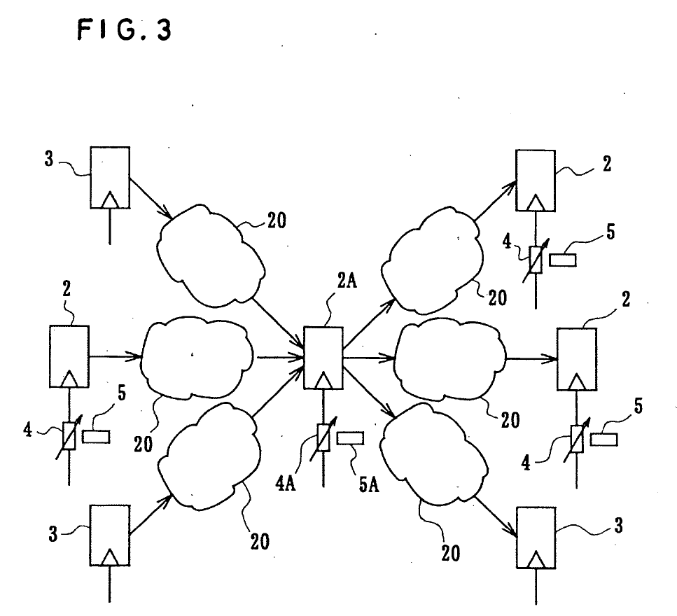

Generally, the delay settings of the adjustable delay elements 4 have a mutual effect. That is, as shown in FIG. 3, adjusting the delay setting time of an adjustable delay element 4A connected to a flipflop 2A affects other flipflops 2 that are adjusted that are connected to the input and output terminals of the flipflop 2A via combinational circuits 20.

In this way, in many cases a combinatorial explosion occurs in the adjustment search space. For this reason, the adjustment method described below that uses a genetic algorithm based on the present invention is very effective.

In this embodiment, the delay setting time of the adjustable delay element 4 connected to the clock terminal of the flipflop 2 that is adjusted is adjusted so that the digital system 1 operates without error.

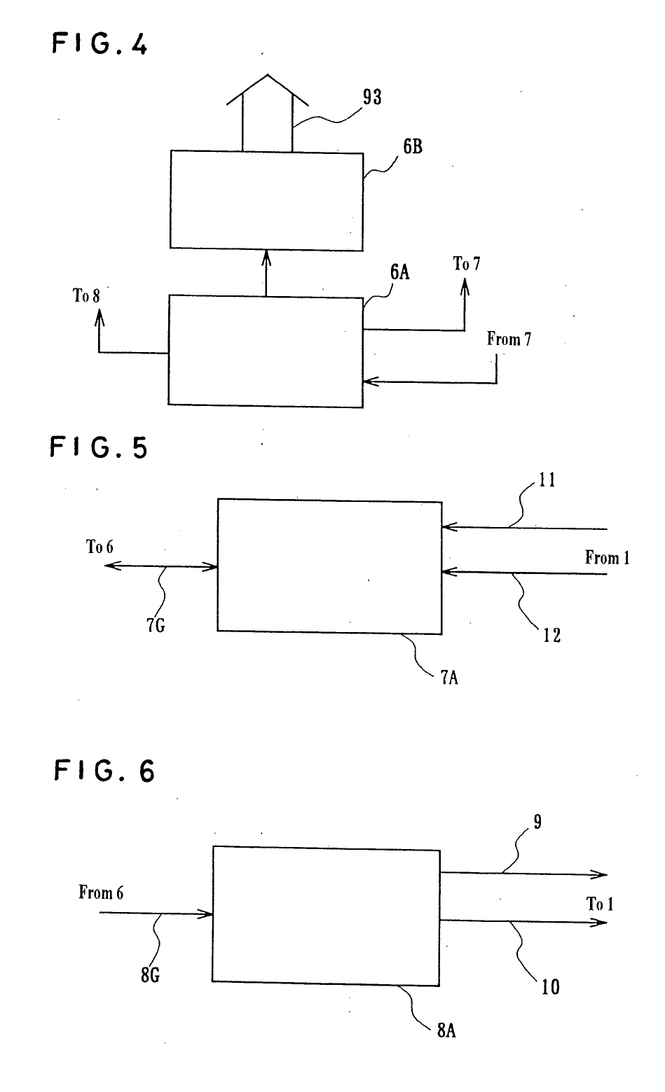

FIG. 4 shows an example of a configuration of the above adjustment apparatus 6. In FIG. 4, symbol 6A is an adjustment algorithm execution apparatus that sequentially executes the adjustment sequence according to the method of the present invention, and 6B is a delay setting apparatus that writes the delay setting to the registers of the digital system 1.

In the adjustment of this embodiment, the above delay setting apparatus 6B writes the delay setting calculated by the adjustment algorithm execution apparatus 6A to the registers 5 via the delay setting signal 93. The delay setting signal 93 controls the delay time generated by the adjustable delay element 4 to have a digital value with the same bit width as the registers 5.

The adjustment algorithm execution apparatus 6A uses a genetic algorithm to search for optimal values for the delay settings of the registers 5. The adjustment apparatus 6 can be constituted, specifically, as an electronic computer, such as a personal computer or microcomputer or the like, and may also be constituted using the programmable LSI disclosed in the publication of unexamined Japanese patent application No. JP-A-9-294069, or the circuit described in the paper by Kajitani et al. “Implementation of Structural Learning Circuits for Neural Networks by GA” (Journal of the Japanese Neural Network Society, vol. 5, No. 4, pp. 145-153, 1198).

In the above electronic computer, the program that implements the functions of the adjustment algorithm execution apparatus 6A may be stored on a hard disk, in ROM (read-only memory) or Flash memory, or on optical disk, magneto-optical disk, magnetic disk or other such recording media.

In FIG. 1, symbol 9 is a clock signal generated by the digital test signal generation apparatus 8 and 10 is a test signal generated by the digital test signal generation apparatus 8; these signals are input to the digital system 1.

Also in the same figure, 11 is a digital output signal output by the digital system 1, 12 is a digital system internal state signal taken from the outputs of some or all of the flipflops; these signals are input to the digital signal observation apparatus 7.

FIG. 5 shows an example of the configuration of the above digital signal observation apparatus 7. The digital signal observation apparatus 7 consists of just a logic analyzer 7A. A logic analyzer is a measurement apparatus that measures digital signals within a digital system.

The logic analyzer 7A and digital system 1 are connected by a measurement probe of the logic analyzer 7A, and the logic analyzer 7A and adjustment apparatus 6 are connected by a GP-IB interface 7G.

The logic analyzer 7A may also be configured as a dedicated circuit incorporated in the digital system 1.

When the digital system 1 operates without error, the values of the digital output signal 11 and digital system internal state signal 12 are stored in the above logic analyzer 7A, which compares them with the output of the digital system 1 and calculates an evaluation value.

Alternatively, the values of the digital output signal 11 and digital system internal state signal 12 when the digital system 1 operates without error are kept stored in the adjustment apparatus 6, and the unmodified values of the digital output signal 11 and digital system internal state signal 12 may be sent from the digital system 1 to the adjustment apparatus 6, and an evaluation value is calculated at the adjustment apparatus 6.

FIG. 6 shows an example of the configuration of the above digital test signal generation apparatus 8. The digital test signal generation apparatus 8 consists of just a digital signal generator 8A.

The digital signal generator 8A and digital system 1 are connected by a probe of the digital signal generator 8A, and the digital signal generator 8A and adjustment apparatus 6 are connected by a GP-IP interface 8G.

The digital signal generator 8A keeps data patterns of the digital signals it outputs in an internal memory, which is output to the digital system 1 as a digital signal 10 synchronized with a clock signal 9 of a specified frequency.

The digital test signal generation apparatus 8 may also be configured as a dedicated circuit incorporated in the digital system 1.

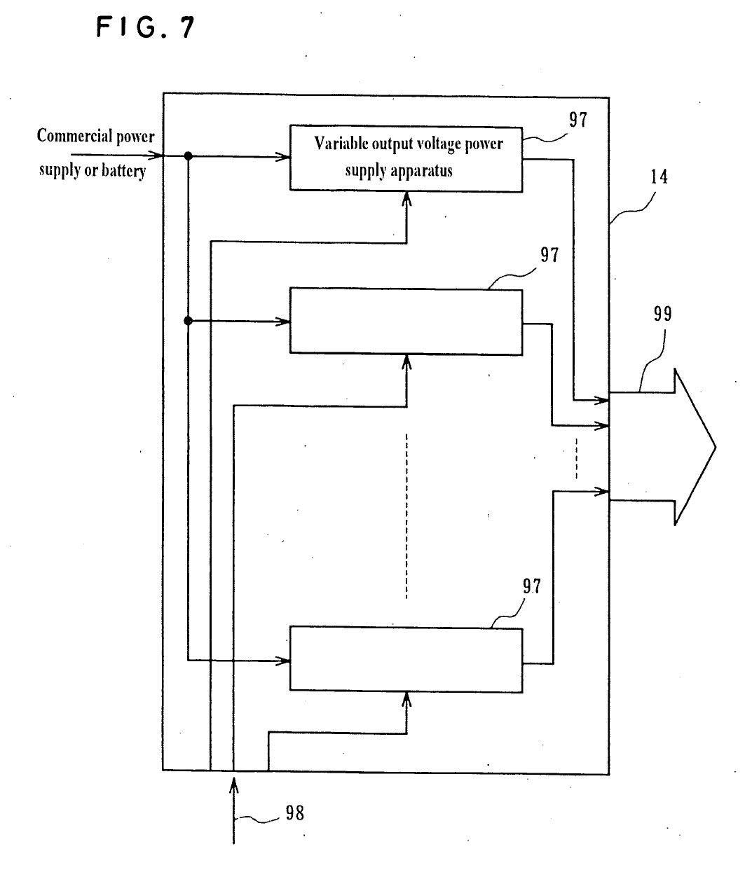

FIG. 7 shows an example of the configuration of the above electric power supply apparatus 14. The electric power supply apparatus 14 is comprised of a required plurality of variable output voltage power supply apparatuses 97. The electric power supply apparatus 14 receives a supply of electric power from an external commercial AC 100 volt source or a battery, and distributes it to the internal variable output voltage power supply apparatuses 97. Each of the variable output voltage power supply apparatuses 97 is a circuit that generates a single supply voltage, and the output voltage thereof can be changed by an external electric power supply control signal 98. The outputs of the plurality of variable output voltage power supply apparatuses 97 are output externally as electric power supply 99.

The output of the electric power supply apparatus 14 may include a fixed voltage output, and variable output voltage power supply apparatuses 97 may be used that have a fixed output voltage.

In the digital system 1, the total number of adjustment locations of the flipflops 2 that are adjusted is a plurality, and the present invention is particularly effective in cases in which an adjustment made to an adjustment location 2A affects the adjustment results at many other adjustment locations, as in the case of the adjustment locations of the delay elements 2 shown in the example of FIG. 2, producing a combinatorial explosion in the adjustment search space.

A major feature of the digital system 1 of this embodiment is that it uses a plurality of flipflops 2 that are adjusted having adjustable delay time delay elements 4 connected to the clock terminals thereof which adjust delay times according to settings from an external apparatus, uses a probabilistic search algorithm executed by the adjustment apparatus 6 to search for optimal delay values, and does not directly measure the delay times.

In a conventional clock timing adjustment method based on contrived circuits, the timing of the clock signals supplied to each of the circuit blocks and flipflops in the digital system is measured using a timing comparison circuit. That is, adjustment is performed by comparing the timing of a reference clock signal and a clock signal to be supplied and feeding back the difference thereof to a timing adjustment circuit, to reduce the measured difference.

There are at least two clear problems with this method. The first problem is the accuracy of the comparison. When a method uses a reference clock, the clock skew of the reference clock itself becomes a problem. When adjacent clocks are compared, clock skew arising from the wiring through which the clock signals supplied to the circuit blocks and flipflops are taken to the comparison circuits becomes a problem.

The second problem is that even if the clock skew is reduced to 0, the ideal, the fact is that the operational yield of the digital system will not be at its maximum operating yield. That is, even if it is assumed that the state of the clock system that supplies the clock signals is ideal, there will be still be deviations from the timing of the design specifications due to process variations and the like in the case of other logic circuits, whereby the logic elements in the digital system operate at a timing that is not in an ideal state.

The original object of eliminating clock skew is so the “digital system operates as the designer intended.” Returning to this original object, the present inventors hit upon the idea of not directly measuring the clock timing, but quantitatively measuring whether the digital system is operating as intended by the designer, or if it is not operating as intended, the ratio by which it is operating incorrectly, and using that value as a basis for adjusting the clock timing.

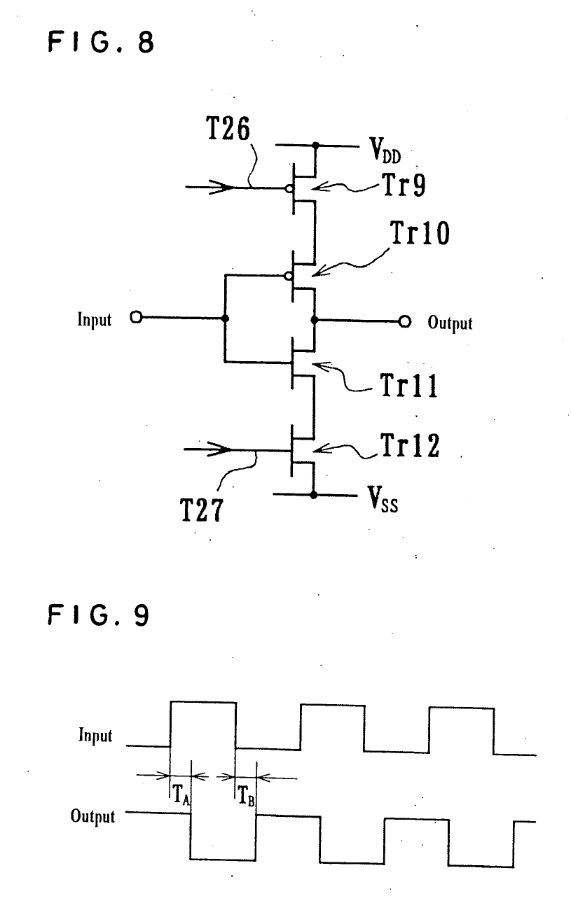

FIG. 8 shows an example of a configuration in which a delay time (signal transmission timing) is changed by the adjustable delay element 4. In the circuit, p-channel FETs Tr9 and Tr10, and n-channel FETs Tr11 and Tr12 are connected in series, and Tr10 and Tr11 function as NOT elements. At this time, the circuit current value is changed by the resistance values of the Tr9 and Tr12, so stray capacitance (parasitic capacitance) and load capacity change the charge and discharge times. FIG. 9 shows the waveforms of an input signal (input clock signal) to the above NOT element and an output signal (output clock signal) from the NOT element. The delay time TA can be adjusted by the voltage of the control signal input to T27 and the delay time TB by the voltage of the control signal input to T26.

One of either Tr9 and Tr12 can be omitted when it is only necessary to adjust the delay of just one of either the rise or fall of the clock signal.

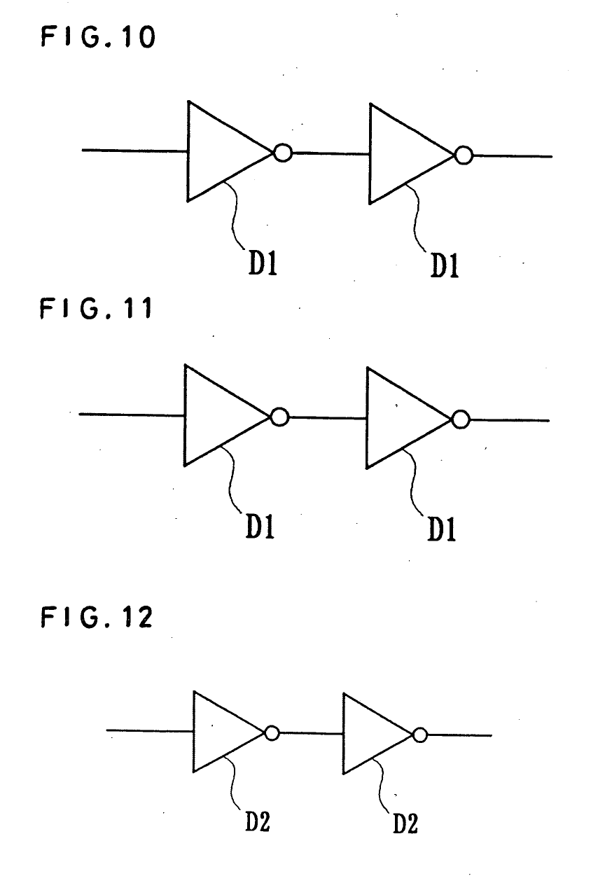

FIGS. 10 to 13 show examples of other configurations in cases where the delay time (signal transmission timing) is changed by the adjustable delay element 4.

As shown in FIG. 10, a delay time of 2DN can be generated by arraying two NOT elements D1 having a unit delay DN in a cascade (line).

As shown in FIG. 11, a delay time of 4DN can be generated by arraying four NOT elements having a unit delay DN in a cascade.

Similarly, a delay time of (2n×DN) can be generated by using a cascade of 2n NOT elements having a unit delay DN.

If larger transistors are used to constitute NOT element D2, it increases the parasitic capacitance, enabling longer delays to be generated, making it possible to change delay times without increasing the number of elements, as shown in FIG. 12.

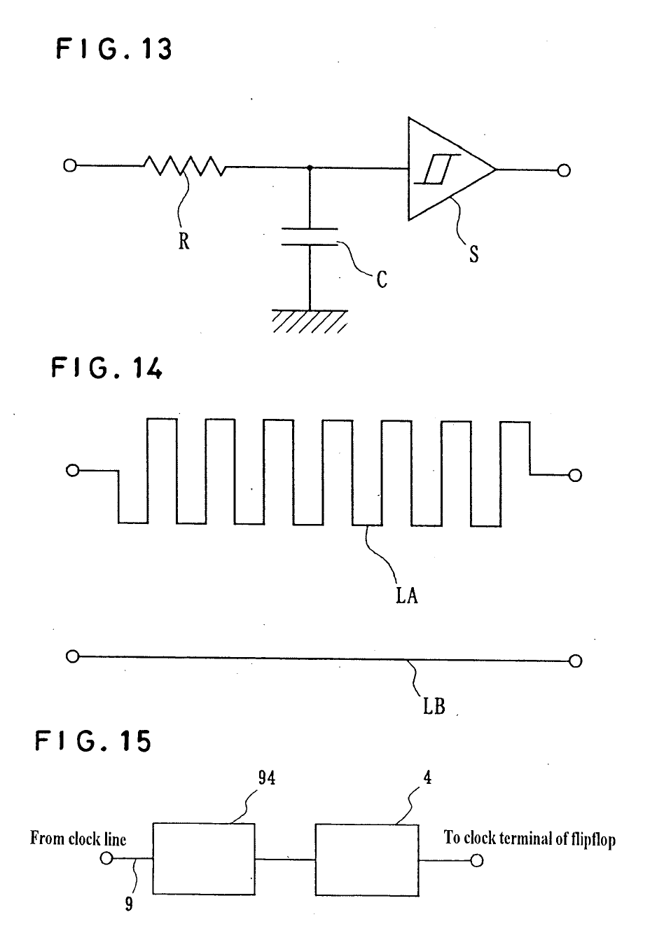

On the other hand, as shown in FIG. 13, a delay circuit can be configured by using resistance R and capacitor C to constitute an integrating circuit, and using a Schmidt trigger element S or the like to shape the waveform of the output. With such a configuration, it is possible to generate a delay that is proportional to the product of the values of the resistance R and capacitor C.

Moreover, the delay of the wiring itself can be utilized by forming long wires to use as delay elements, in which case the delays produced are proportional to the length of the wire.

In the case of FIG. 14, for example, with respect to wire LB of length LLB, shown in the lower part of the figure, of the same material and width as wire LA of length LLA shown in the upper part of the figure, wire LA generates LLA/LLB times the delay.

The only function the above delay elements have is to delay a clock signal, but by using a PLL (phase-locked loop) circuit or DLL (delay-locked loop) circuit, they can also be used to generate a negative delay that advances the clock signal.

FIG. 15 shows an example of a configuration of an adjustable delay circuit that generates delays in both positive and negative directions.

In FIG. 15, symbol 94 is an aforementioned PLL circuit, and symbol 4 is the adjustable delay circuit (delay element) shown in FIG. 16 that is described later. In a case in which PLL circuit 94 has the function of advancing the clock by the amount 8DT and the adjustable delay circuit 4 has the function of generating a delay from 0DT to 15DT, overall, the circuit can generate a delay of from −8DT to 7DT.

The adjustable delay element 4 may be constituted by combining a plurality of the above delay elements.

FIG. 16 is a schematic diagram showing an example of a configuration of an adjustable delay element 4. The adjustable delay element 4 of this example corresponds to a case in which the register 5 in FIG. 1 holds 4 bits of data.

This adjustable delay element 4 is configured so that, via a switch drive circuit that is not shown, each register bit value held in the register 5 corresponds to each of the switch circuits Sw1˜Sw4 and operates each of the switch circuits Sw1˜Sw4 corresponding to the above register values, and clock signals with the delays thus generated are applied to the clock terminals of the above flipflops 2 that are adjusted.

That is, the adjustable delay element 4 shown in FIG. 16 is constituted of delay elements UD1˜UD4 that each generates a different, fixed delay time, and switch circuits Sw1˜Sw4 for selectively using the delay elements UD1˜UD4.

Here, delay elements UD1˜UD4 and the switch circuits Sw1˜Sw4 corresponding to the delay elements are connected in a mutually differing cascade (line) between the clock input from the clock line and the clock terminal of the flipflop 2 that is adjusted, forming a configuration whereby delay times generated by the delay elements are imposed on the clock signal, and the clock signal delayed from the original clock signal by the amount of the generated delay time is supplied to the clock terminal of the flipflop 2 that is adjusted.

In the configuration used here, the delay element UD1 generates a delay time of a length determined by the design; delay element UD2 generates a delay time that is twice as long as the delay time of the delay element UD1; and similarly, delay element UD3 generates a delay time that is four times as long as the delay time of the delay element UD1; and delay element UD4 generates a delay time that is eight times as long as the delay time of the delay element UD1.

The On-Off switching of the switch circuits Sw1˜Sw4 corresponding to the delay elements UD1˜UD4 is controlled based on the register values of the register 5. When one of the four register bit values is “1”, the switch circuit corresponding to that bit is switched to the delay element side and a delay time generated by the corresponding delay element is imposed on the clock signal. When one of the four register bit values is “0”, the switch circuit corresponding to that bit is switched to the bypass side, so the corresponding delay element is skipped and a generated delay time is not imposed on the clock signal.

Therefore, since here the clock signals are subjected to the generated delay times of the delay elements UD1˜UD4 set at 1DT, 2DT, 4DT, 8DT, the adjustable delay element 4 can adjust the delay time imposed on the clock signals in the range from a delay time of 0 to a delay time of 15DT, depending on the combination state of the switch circuits.

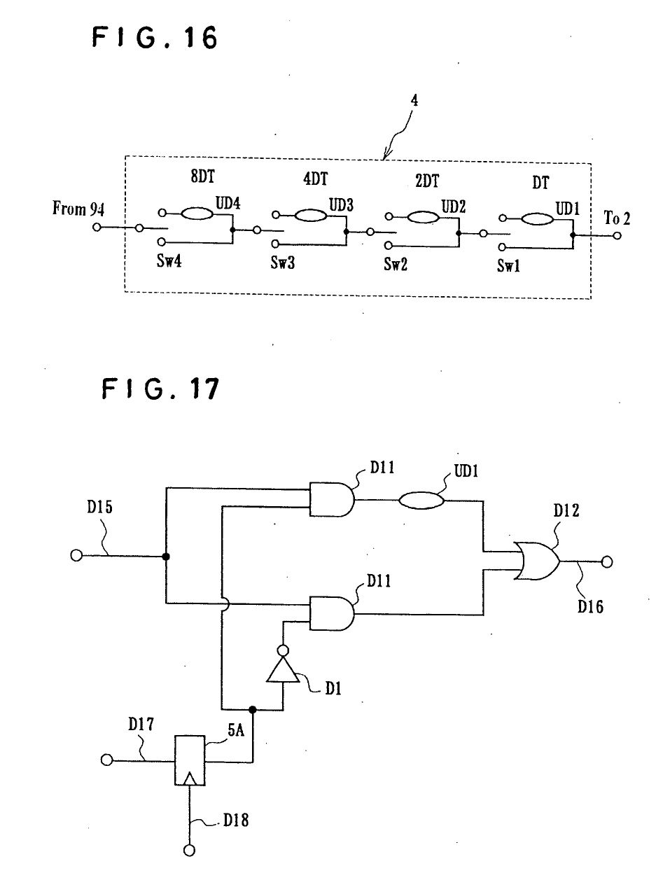

FIG. 17 shows an example of a configuration that includes the adjustable delay element 4 and the least significant bit 5A of register 5.

In FIG. 17 symbol D1 is a NOT element, D11 AND elements, D12 an OR element, UD1 a unit delay circuit, 5A the least significant bit (one bit) of the register 5, and D15 the clock input from the clock line. Clock output D16 is input to the clock terminal of a flipflop 2 that is adjusted. D17 is a delay setting input to the register 5A, and D18 is a signal written into the register 5A; the delay setting signal 93 is comprised of all of the register 5 bits together plus all of the register amounts combined.

The switch here is a basic selector circuit using the AND element D11 and OR element D12. The delay element UD1 that generates a delay DT is inserted on the output of one AND element D11, and the output of the other AND element D11 is connected directly to the OR element D12, skipping the delay element UD1.

That is, when the output of the register 5A is a logical value “1”, the AND element D11 on the delay element UD1 side functions to generate a delay DT, and when the output of the register 5A is a logical value “0”, the AND element D11 on the side of the skipped delay element UD1 does not function to generate a delay.

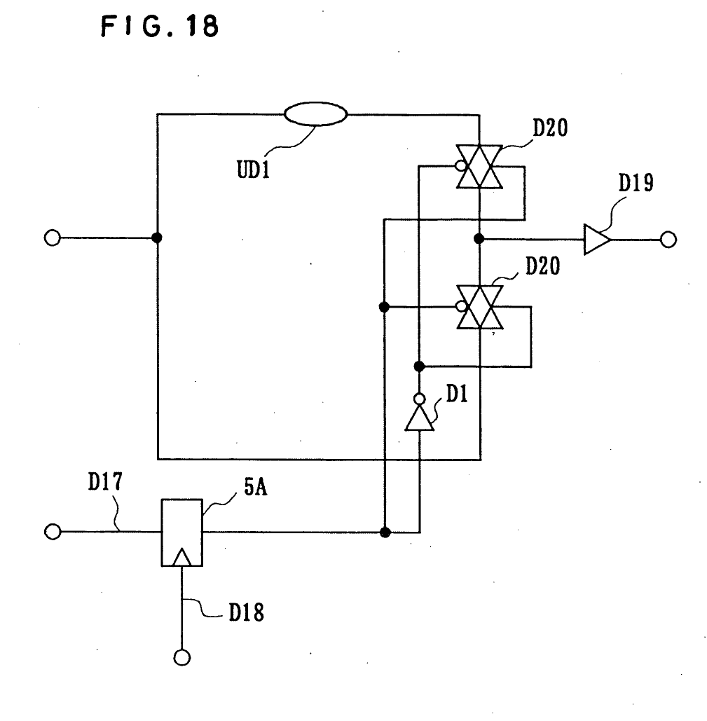

FIG. 18 shows another example of a configuration that includes an adjustable delay element 4 and a one-bit portion D13 of the register 5.

The configuration of this example comprises transfer gate elements D20 and a buffer D19. The transfer gate element D20 functions as a switch, having a function similar to that of the above combined AND and OR elements.

It goes without saying that other digital circuits having functions similar to these configuration examples can be readily configured and used in place of those of the above-described embodiments.

The digital system internal state signal 12 is comprised of the outputs of some or all of the flipflops 2 that are adjusted and flipflops 3 that are not adjusted within the digital system 1, and is input to the digital signal observation apparatus 7.

The digital system internal state signal 12 can be input to the digital signal observation apparatus 7 by, for example, preparing an output terminal of the digital system 1 for the output from the flipflops, and connecting it to the digital signal observation apparatus 7.

If the number of bits of the digital system internal state signal 12 is too high, a method may be used in which the output from the flipflops is divided into a plurality of groups for input to the selector circuit, and the same test signal 10 is repeatedly applied while switching the groups output from the digital system 1.

Alternatively, a method may be used in which a scan-pass circuit is incorporated in the digital system 1, the test signal 10 and clock signal 9 are stopped in mid-operation, at which point the scan-pass circuit is used to extract the internal state of the digital system 1 and pass it to the digital signal observation apparatus 7.

This scan-pass circuit is a circuit that can realize an operating mode in which the outputs of some or all of the flipflops in the digital system 1 are made to operate as a single or plurality of shift registers, making it possible to observe the internal state during the operation of the digital system 1, and set the internal state from the outside.

A method of setting the delay value from the delay setting apparatus 6B shown in FIG. 4 to the register 5 will now be explained.

The one-bit portion 5A of the register 5 has a setting input signal D17 and a set (write) designation signal D18, such as in FIG. 17; the delay setting signal 93 is comprised of these two types of signals in respect of all registers. The delay setting signal 93 is output from the delay setting apparatus 6B and input to the digital system 1.

The delay setting apparatus 6B may, for example, be configured using the parallel interface board of a personal computer, with a number of bits that is the amount of the width of the delay setting signal 93.

Of the delay setting signals 93 output as parallel interface output signals of the delay setting apparatus 6B, an 0 or 1 signal is applied to a delay setting signal connected to a setting input terminal bit of the register 5, and can be written to the register by applying a signal designating the setting of the bit connected to the corresponding setting signal.

The value written to the register at this time is a value calculated by the adjustment algorithm execution apparatus 6A.

Alternatively, all of the registers 5 in the digital system 1 may be numbered and the delay setting signal 93 comprised of these register numbers, the values written to the registers, and setting instruction signals.

In this case, the delay setting signals 93 sent from the delay setting apparatus 6B to the digital system 1 would be sorted according to register number using multiplexer circuits in the digital system 1, the delay setting signals would be applied to the setting input terminals of the registers specified by register number, applying the setting instruction signals as setting instruction signals of the specified register.

The connection of the delay setting apparatus 6B and digital system 1 in this case, too, can similarly use a parallel interface board.

Alternatively, in the delay setting apparatus 6B, the settings for all registers can be arranged in a line and subjected to parallel-serial conversion to generate a serial signal (a signal one bit wide) that is used as the delay setting signal 93.

In this case, the delay setting signal 93 is subjected to serial-parallel conversion within the digital system 1 and each setting written to the respective register. The delay setting signal 93 is a one-bit-wide signal, so an RS-232C or other such serial interface circuit can be used for the connection between the delay setting apparatus 6B and the digital system 1.

Next, a first embodiment of the adjustment method of the present invention for adjusting the digital system 1 of the above embodiment will be described.

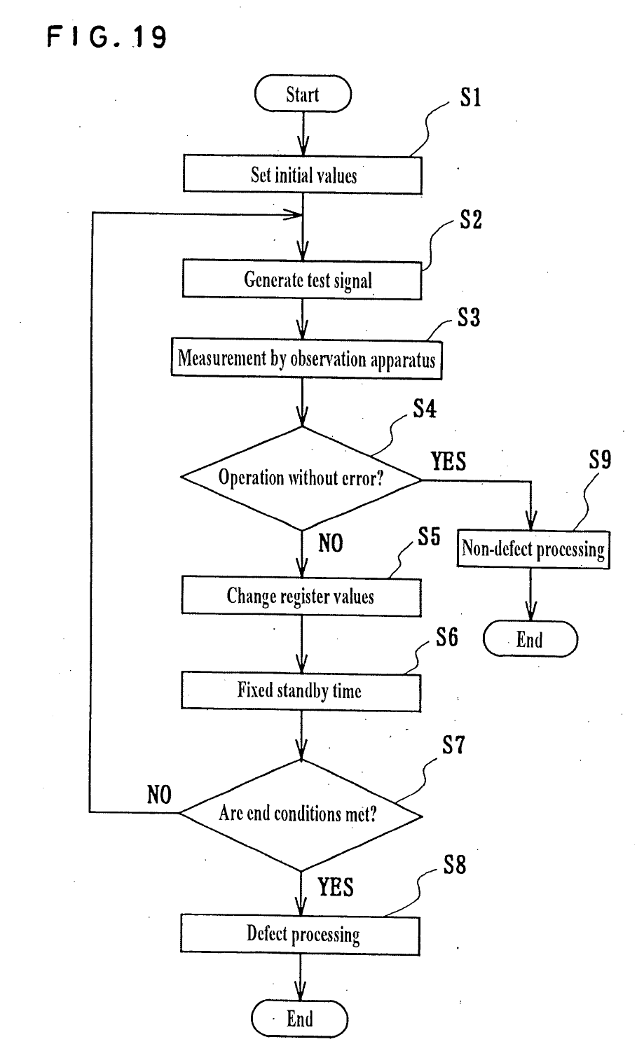

In the adjustment process after the above digital system 1 has been manufactured, as shown in FIG. 1, the adjustment apparatus 6, digital signal observation apparatus 7, digital test signal generation apparatus 8, and electric power supply apparatus 14 are each connected to the digital system 1, the digital test signal generation apparatus 8 inputs digital test signal 10 and clock signal 9 to the digital system 1 and the adjustment apparatus 6 sets the register values of the register 5 in accordance with the processing sequence shown in FIG. 19.

In this processing sequence, first, in Step S1, the adjustment apparatus 6 writes predetermined initial set values to the register 5 which are stored as register values. Next, in Step S2, the digital test signal generation apparatus 8 outputs a test signal, and in response to the test signal the digital system 1 is operated based on a fixed frequency clock signal 9 and a fixed voltage power supply 99. Next, in Step S3, the output of the digital system 1 and the internal state of the digital system are measured by the digital signal observation apparatus 9 and the result transmitted to the adjustment apparatus 6. Then, in Step S4, the adjustment apparatus 6 uses the received observation value to determine whether or not the digital system 1 is operating without error. Here, the voltage value of the electric power supply 99 may be made lower than the design supply voltage value of the digital system 1.

In a case in which there is error in the operation, in Step S5 the adjustment apparatus 6 changes the register values held in the registers 5, and next, in Step S6, there is a standby of a fixed length of time until the results of the change stabilize, then in Step S7 it is decided whether or not the end conditions have been satisfied, and if the end conditions have been satisfied, the processing ends after the defect processing of Step S8, but if the end conditions are not satisfied the process reverts to Step S2 and this series of steps is executed repeatedly. When in the above Step S4 a determination that the digital system 1 has operated without error is obtained, the processing ends after the no-defect processing of Step S9.

Regarding the method of changing the register values from the initial settings described above, several methods can be used, examples of which are described below.

That is, the first method is a method in which the settings are switched to all conceivable combinations within the range of register values in an appropriate order; the second method is a method in which the settings are generated randomly. The third method is a method in which the delay time generated during designing are taken as the initial settings and the settings are changed minutely from these initial settings in both the positive and negative directions.

In cases in which the number of adjustable delay elements 4 in the digital system 1 subject to adjustment is small so a combinatorial explosion does not occur in the register values, it is possible to use the first and second methods. However, in the case of this embodiment there is a large number of adjustable delay elements 4, so it is conceivable that a combinatorial explosion will occur within the register value adjustment search space, so the third method is used. There follows an explanation of the digital system 1 adjustment method using a genetic algorithm.

Reference literature for the above-mentioned genetic algorithm includes, for example, “Genetic Algorithms in Search, Optimization, and Machine Learning,” by David E. Goldberg, published in 1989 by Addison-Wesley Publishing Company, Inc. The genetic algorithm referred to in the present invention refers to an evolutionary computation technique.

The extent to which the digital system 1 operates without error can be represented by an evaluation function F which takes the delay values of all the adjustable delay elements as its arguments (input). To have the digital system 1 operate without error is equivalent to finding the delay values that optimize the evaluation function F. Noting this point, the present inventors discovered that the above-mentioned genetic algorithm is applicable to the adjustment of the digital system 1. The adjustment apparatus 6 changes the register values of the registers 5 according to this genetic algorithm.

In a genetic algorithm, first a population of virtual organisms having genes is set up, and individuals that are fit for a predetermined environment are given a higher probability of leaving descendants depending on their fitness. Then, the genes of the parents are passed on to the offspring by a procedure called genetic operation. By implementing these generation changes and evolving the genes and the population of organisms, individuals with a high fitness will form the majority of the organism population. Genetic operations that can be used at this time include crossover and mutation of genes, which also occur in the propagation of actual organisms.

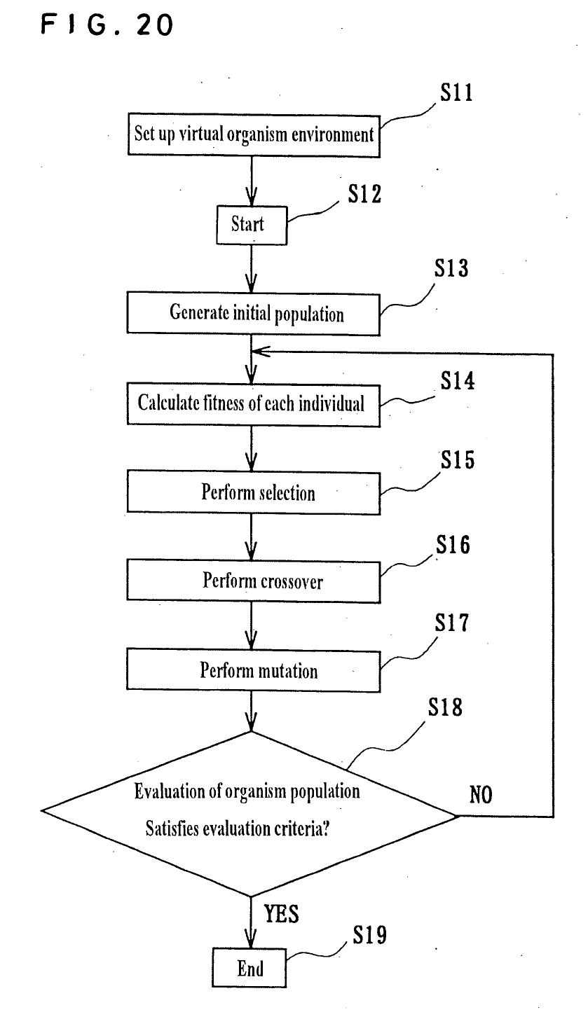

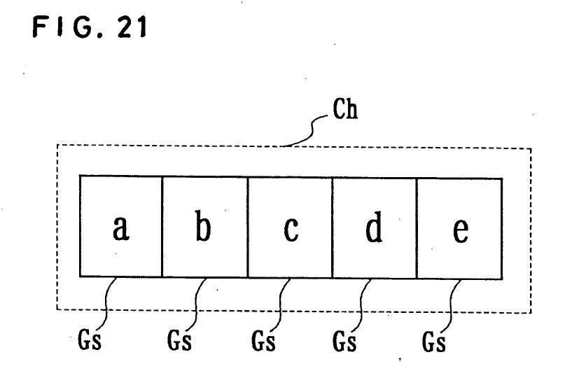

FIG. 20 is a flowchart showing an overview of the sequence of the genetic algorithm. Here, first, in Step S11, the chromosomes of an individual are determined. That is, here it is decided what data in what form will be transmitted from an individual parent to an individual offspring at the time of generation change. FIG. 21 shows an example of a chromosome. Here, the variable vector x in the optimization problem to be solved is represented as a sequence of M symbols Ai (i=1, 2, . . . M) and this is assumed to be a chromosome consisting of M gene loci. Each of the symbols Ai is a gene, and the values that they can take are alleles. In FIG. 21, Ch denotes the chromosome and Gs the gene loci, and the number of gene loci M is five. The alleles can be pairs of certain integers, real numbers within a certain range or a sequence of simple symbols or the like, and these can be determined depending on the problem. In the example of FIG. 21, the letters a˜e are the alleles. A set of genes encoded in this manner is the chromosome of an individual.

Next in the above Step S1, the method of calculating the fitness which represents the degree to which each individual is fit for the environment is determined. This is done using a design whereby the higher the variable or the lower the variable that is the value of the evaluation function for the optimization problem concerned, the higher the fitness of the corresponding individual becomes. Also, in the change of generations to be subsequently performed, the higher the fitness of an individual is, the higher its probability of surviving and leaving descendants becomes, compared to that of individuals having a lower fitness. Conversely, individuals with a low fitness are assumed to be individuals that are not very fit for the environment and die out. This reflects the principle of natural selection in the theory of evolution. That is, fitness becomes a measure of the degree of superiority of each individual when viewed from the perspective of viability.

In the genetic algorithm, at the start of the search, the problem to be solved is typically completely a black box, so the type of individual that is desirable is unknown. For this reason, the initial population is generated randomly using random numbers. Therefore, in the sequence here, too, in Step S13 following the start of the processing in Step S12, the initial population is generated randomly using random numbers. In the event that there is some foreknowledge regarding the search space, it is possible to generate the organism population centered around the portions where the evaluation value is thought to be highest, or other processing may be performed. Here, the total number of individuals to be generated is called the population size.

Next, in Step S14, the fitness of each individual within the population is calculated based on the calculation method determined previously in Step S11. Once the fitness of each individual is found, individuals are selected in Step 15 from the population to form the foundation of the next generation. However, if selection alone is used, the ratio of the individuals within the population that have the highest fitness at the current point in time will simply increase, and no new search points will be generated. For this reason, the operations described below called crossover and mutation are performed.

That is, in the next step, Step S16, pairs of two individuals are selected at random at a prescribed occurrence frequency from among the individuals of the next generation generated by selection, and their genes are combined (crossed) to create the genes of the offspring. Here, the probability of crossover occurring is called the crossover rate. Individual offspring generated by crossover inherit traits from each of the individuals that were its parents. By means of this crossover process, diversity in the individuals' chromosomes is increased and evolution occurs.

Following the crossover process, next, in Step S17, the genes of an individual are subjected to changes (mutations) at a fixed probability. Here, the probability of mutation occurring is called the mutation rate. The phenomenon of contents of genes being rewritten at a low probability is a phenomenon that can be seen in the genes of actual organisms. However, if the mutation rate is made too high, the characteristic of genetic traits being inherited from parents through crossover is lost, so this would be the same as randomly searching through the search space, so care is therefore required in this regard.

Once the population of the next generation is determined by the above process, next, in Step S18, it is determined whether or not the population in the next generation thus generated satisfies the evaluation criteria for ending the search. These evaluation criteria depend on the problem, but the following are typical ones.

The maximum fitness of the population is greater than a certain threshold value.

The average fitness of the population is greater than a certain threshold value.

Generations in which the rate of increase in the fitness of the population is at or below a certain threshold value have continued for longer than a fixed period.

The number of changes in generations has reached a predetermined number.

In the event that any of the above end conditions (evaluation criteria) is met, the process proceeds to Step S19 and the search ends, at which time the individual among the population that exhibits the highest fitness is assumed to be the sought-after solution to the optimization problem. In the event that the end conditions are not met, there is a return to the process of calculating the fitness of the individuals of Step S14, and the search continues. By repeating the change of generations in this way, the number of individuals in the population can be maintained constant while the fitness of individuals can be increased. This completes the overview of the genetic algorithm.

The framework of the genetic algorithm described in the foregoing is a moderate one that does not stipulate details of the actual programming, and does not stipulate the detailed algorithms for individual problems. That being the case, in order to use a genetic algorithm in the adjustment of the digital system of this embodiment, the following items have to be realized for digital system adjustment.

(a) Method of representing chromosomes

(b) Evaluation function for individuals

(c) Selection method

(d) Crossover method

(e) Mutation method

(f) Search end criteria

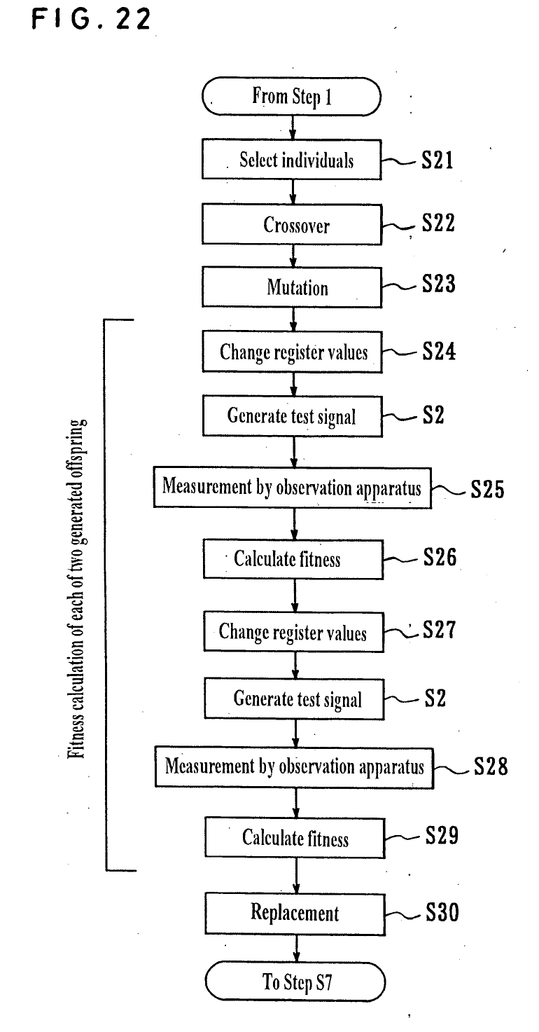

FIG. 22 is a flowchart showing the processing sequence of the adjustment apparatus 6 using a genetic algorithm in the method of this embodiment. The processing in this FIG. 22 shows the processing of Step S2˜Step S6 of FIG. 19 in specific detail. A major characteristic of this embodiment is that the register values of the registers 5 are used directly as the chromosomes of the genetic algorithm, thereby eliminating the need for any processing or the like to convert the chromosome information to register values. That is, the chromosomes in this embodiment are constituted from the register values of the plurality of registers 5.

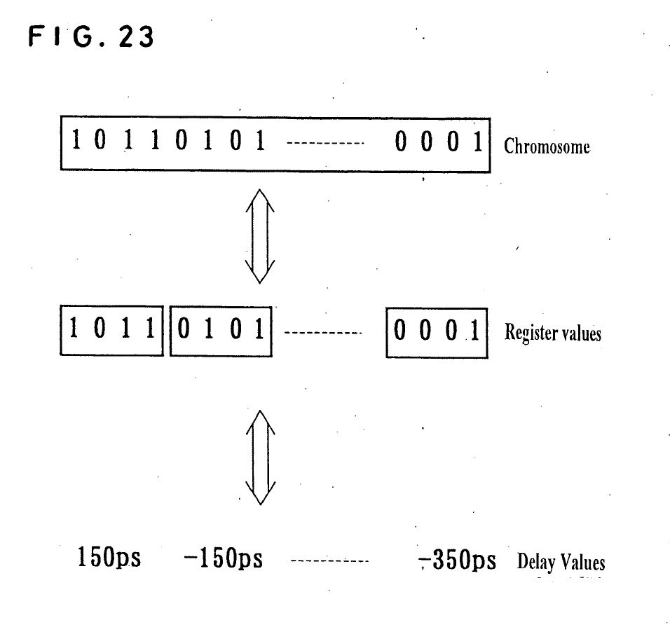

In addition, a positive sign (no sign) signifies the signal is delayed by the time of the delay value in FIG. 23, and a negative sign that the signal is advanced by that time, and the delay value unit ps signifies picoseconds.

As the evaluation function F for individuals in the genetic algorithm used in the process of FIG. 22, a function that expresses how close the logical value of the digital output measured by the digital signal observation apparatus 9 is to the expected value is used and operated after the digital system 1 is set with the register values that represent the chromosomes of the individuals.

In order to be used in the process shown in FIG. 22, a plurality of individuals is first prepared using uniformly random numbers as the initial population of the genetic algorithm in Step S1 of FIG. 19. That is, in this case, this means that the value of each gene of each chromosome in the initial population takes a value of 1 at a probability of 0.5, and a value of 0 at a probability of 0.5. However, in a case in which there exists some foreknowledge regarding the non-uniformity tendencies in the clock timing, it is possible to create individuals considered to have a higher fitness as the initial population.

Using the above evaluation function, the adjustment apparatus 6 calculates the fitness of each individual of the initial population from the evaluation value sent from the digital signal observation apparatus 7 (Step S3). Following that, in Step S4 it is determined whether or not the digital system 1 performance is operation without error, and if it is operating without error, the adjustment processing ends after the no-defect processing of Step S9.

If the no-defect processing of Step S9 cannot be effected with respect to all of the individuals of the initial population, the process proceeds to the genetic processing of Steps S21˜S30. If during the fitness calculation processing of Step S26 or Step S29 it is determined that the performance of the digital system 1 is operation without error, the adjustment processing ends after the no-defect processing of Step S9. If no chromosomes (register values) can be obtained that operate without error even after performing Steps S21˜S30 repeatedly for a fixed number of generations to make the adjustment process, the digital system 1 subject to adjustment is determined to be defective and processed as the defective in Step S9.

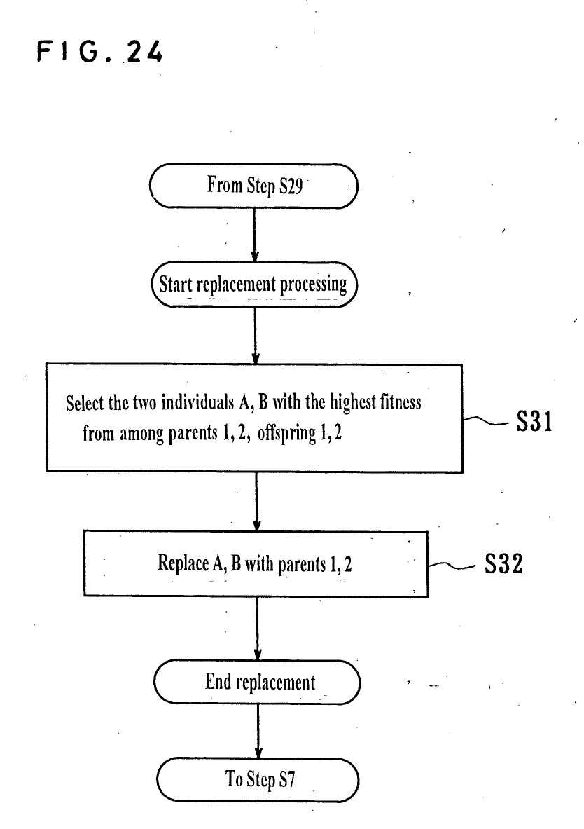

The genetic algorithm selection process is the process of selecting from the population the individuals that will be left in the next generation, and is carried out from Step S21 to Step S30. In this embodiment, as shown in the process flow of FIG. 22, for example two individuals 1, 2 are randomly selected from the population (Step S21), these are crossed and a mutation applied to create offspring 1, 2 (Steps S22˜S29), then, as shown in the process flow of FIG. 24, of the four individuals parent 1, parent 2, and offspring 1, offspring 2, the two individuals A, B having the highest fitness values are selected (Step S31), and the individuals A, B are replaced with parents 1, 2 in the population (Step S32). A major feature of this replacement process is that unlike general genetic algorithms, it does not change all of the individuals of the population at once. Thereby, it is possible to perform searches on populations with few individuals.

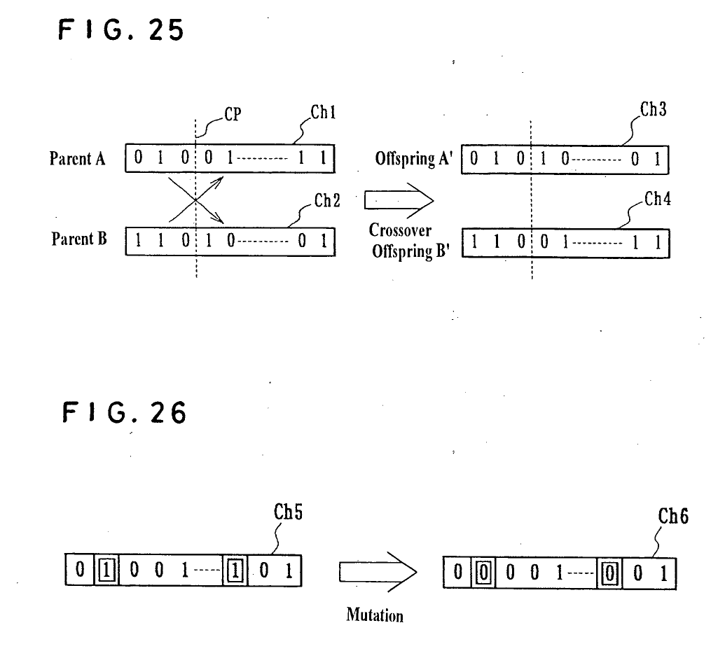

The crossover processing of Step S22 uses the method shown in the explanatory diagram of FIG. 25. This is an operation in which the chromosomes are exchanged at random positions, a technique called one-point crossover. In FIG. 25, Ch1 and Ch2 are the chromosomes of the parents A, B that survived as a result of selection, and in this crossover process, these chromosomes are cut at a randomly selected crossing point CP. In the example of FIG. 25, the point between the third and fourth genes from the left is the crossing point. Then, by exchanging the cut partial genotypes, offspring A′, offspring B′ which have the chromosomes Ch3 and Ch4, respectively, are created and replace the original individuals A, B.

The mutation of Step S23 that is executed following the crossover of Step S22 is an operation that changes the gene bits of each chromosome from 0 to 1, or from 1 to 0, at the mutation rate occurrence probability. FIG. 26 shows a mutation example. In FIG. 26, mutation occurs in the genes of the second bit from the left and the third bit from the right of the chromosome Ch5, shown enclosed in squares, which are each changed to alleles in the chromosome Ch6.

As described in the above, the digital system 1 of this embodiment uses adjustable delay elements 4 for the clock signals to the plurality of flip-flop elements within the digital system 1, and searches for delay values of these adjustable delay elements 4 whereby the digital system 1 operates without error. Therefore, adjustment is possible whereby deviations in clock timing and the like caused by design error or non-uniformity in clock signal line quality in the digital system manufacturing process can be absorbed, in addition to which insufficient timing margins caused by lowering the supply voltages can be compensated for, so that the digital system 1 operates without error, and this means that, using less design labor than in the case of the conventional technology, it is possible to obtain digital systems that operate at a lower supply voltage than in the case of the conventional technology, that is, digital systems that consume less electric power.

Also, among digital systems 1 that do not operate even when adjusted at the original supply voltage, there exist those that can be adjusted to operate without error by slightly raising the supply voltage, which means that with less labor than in the case of the conventional technology, it is possible to improve the operational yield by increasing the supply voltage by the minimum amount required.

With respect to this embodiment, also, it is possible to use the following adjustment method. That is, with the above-described adjustment method the supply voltage of the electric power supply 99 is set at a fixed value, but after finishing the adjustment, the supply voltage of the electric power supply 99 can be lowered and a similar adjustment performed, making it possible to further reduce the operating voltage.

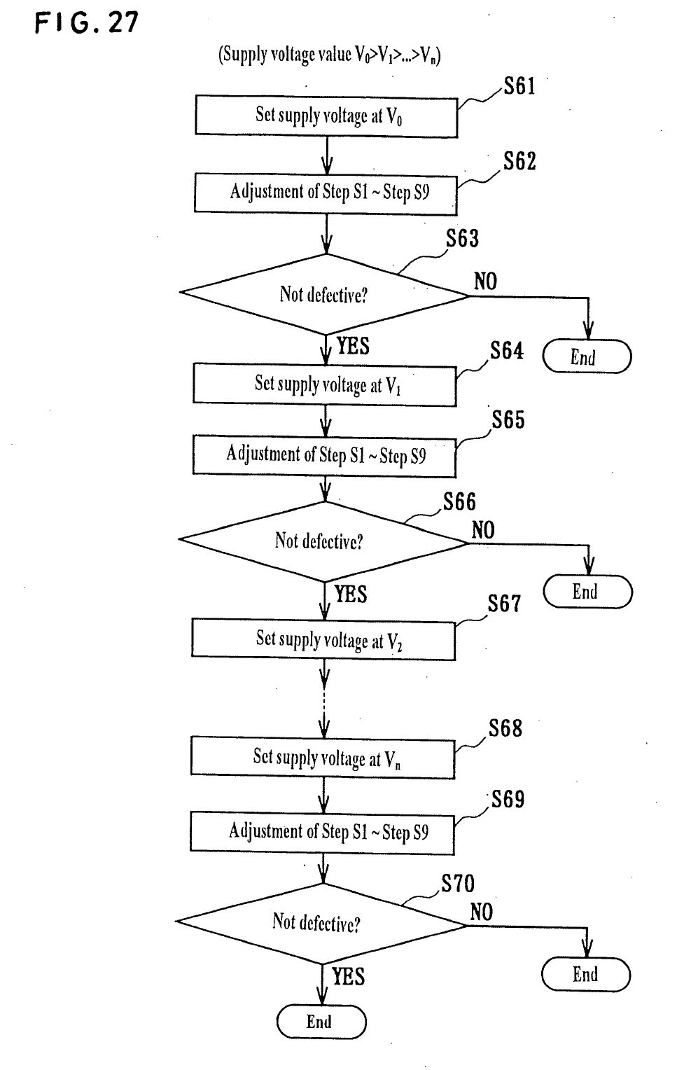

FIG. 27 shows the adjustment method of the above case. First, after setting the power supply 99 supply voltage input to the digital system 1 to V0 in Step S61, in Step S62 the adjustment apparatus 6 performs the adjustment of Step S1 to Step S9 shown in FIG. 19. Next, in Step S63, it is determined whether or not the result of the adjustment of Step S61 is that the digital system 1 has been adjusted to non-defective. In the event that the result of the adjustment is that it has not become non-defective, the processing ends. If the result of the adjustment is that it has become non-defective, in Step S64 the supply voltage of the power supply 99 is set to a value V1 that is smaller than V0. Following that, in Step S65 an adjustment of the digital system 1 similar to that of Step S62 is performed. In Step S66, a determination similar to that of Step S63 is performed, and if it non-defective, adjustment is repeatedly performed with the supply voltage of the power supply 99 set at a smaller value. If as a result of the repetition, the supply voltage of the power supply 99 is set at the lower limit value Vn in Step S68, adjustment is performed in Step S69 and the processing ends.

The supply voltage upper limit value V0 is the digital system 1 design value, and the lower limit value Vn is determined depending on the physically permissible supply voltage. The value of n and the value of V1 to Vn−1 are set according to the required adjustment precision. With this adjustment method, it is possible to reduce the value of the operating supply voltage of the digital system 1, corresponding to the reduction in the timing margin.

Also, when V0 is set above the design value of the supply voltage and the supply voltage Vi (i=1, . . . , n) is gradually adjusted down, the adjustment takes time but has the merit of enabling adjustment to be performed reliably.

With the above adjustment method, moreover, it is possible to increase the stability of a digital system that is determined to be non-defective at a supply voltage Vj by operating the system during use at a frequency of Vi(i<j). This is because since the clock timing is adjusted to operate at a lower supply voltage than when it is used, it is more difficult for malfunction to occur even when the effects of fluctuations in the supply voltage during operation, or digital system temperature or external electromagnetic noise cause slight changes in the clock timing.

Moreover, when in Step S63 of the above adjustment method, it is not adjusted to non-defective, the supply voltage value can be set to Vh (the initial Vh is slightly higher than the design value V0), and the adjustment of Step S1 to Step S9 performed again. In cases where the timing adjustment at this supply voltage value Vh is successful, it is possible to improve the yield by increasing the supply voltage by just the minimum amount required. On the other hand, in cases where adjustment to non-defective could not be done, it is possible to raise Vh in steps and continue with the adjustment.

This adjustment method can also be used in the process of mass-production of the digital system 1. In the conventional mass-production process, non-defectives have generally been selected by conducting just test operations without adjusting the supply voltage. However, in accordance with the above adjustment method, individual adjustment of manufactured digital systems can be performed and the supply voltage reduced, enabling the ratio of digital systems that operate at a low supply voltage value to be increased. A digital system that operates at a low supply voltage, that is, at a low power consumption, has high commercial value, contributing to extending the operating time of mobile devices and the like, so this adjustment method has a high industrial value.

Also, the operational yield of digital systems that cannot be made to operate even when adjusted at the original normal supply voltage can be raised by carrying out adjustment with the supply voltage slightly elevated, which contributes to reducing costs and has a high economic value.

Next, there is the following example of a modification of the first embodiment of the present invention. In the preceding embodiment, the adjustment apparatus 6, digital signal observation apparatus 7, digital test signal generation apparatus 8 and electric power supply apparatus 14 are detachably connected to the digital system 1 as external apparatuses. However, with this invention, circuits corresponding to these external apparatuses may be built into the digital system 1 as adjustment means. In particular, the electric power supply apparatus 14 may be built into the digital system 1 or connected as an external apparatus, independently of the adjustment apparatus 6, digital signal observation apparatus 7 and digital test signal generation apparatus 8.

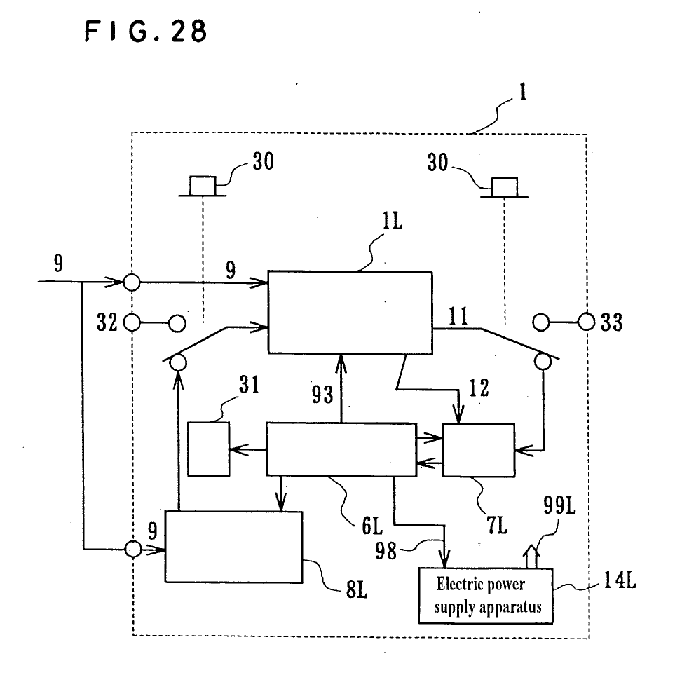

FIG. 28 shows an example of a modification thus configured. Here, circuits corresponding to the digital system unit 1L and the above-described external apparatuses are built into the digital system 1. A switching switch 30 is located between the input terminal and output terminal of the digital system 1L, and between the external input terminal 32 and the external output terminal 33 of the digital system 1L. This switching switch 30 may be provided in the digital system 1L as shown in the drawing, or may be provided outside the digital system 1.

When the switching switch 30 is operated, output of the digital system 1L is input to the digital signal observation apparatus 7L and operation of adjustment circuit 6L, digital signal observation apparatus 7L, and digital test signal generation apparatus 8L is initiated and adjustment of register values is performed. At this time, electric power supply apparatus 14L continues to supply electric power to each of the sections in the digital system unit 1L, but at the same time, the output side supply voltage is changed in accordance with power supply control signal 98 from the adjustment apparatus 6L. When adjustment is finished, digital system 1L output is switched to the output terminal 33 side by operating the switching switch 30. Moreover, in this example, a light-emitting element 31 is provided that displays a warning in cases where register values that enable the digital system 1L to operate without error cannot be obtained.

By means of this modification example, not only can the digital system 1 be adjusted when it is being manufactured, but after a user has purchased a product that incorporates the digital system 1, the user himself can adjust the digital system 1 at any time. Furthermore, after the digital system 1 is manufactured, it can be more adjusted by persons who make a specialty of adjustment of devices. Thus, even in cases where there are changes such as in the temperature of the environment in which the digital system 1L is located and the like, giving rise to changes in the clock timing or data path timing in the digital system unit 1L, there is the merit that those changes can be compensated for, making it possible to reduce the probability that the digital system unit 1L will malfunction. In particularly, in cases where the supply voltage is changed, the clock timing and data path timing change but that can similarly be compensated for, and furthermore, even when the supply voltage is intentionally lowered to reduce the electric power consumption, in the same way the changes in the clock timing or data path timing can be compensated for. Moreover, the switching switch 30 is not limited to being manual, and may be configured to switch automatically when the supply voltage is turned on. With respect to the clock signal 9, also, when a clock signal generation circuit is located in the digital system 1, that clock signal may be used.

Next, a second embodiment of the digital system of the present invention is described. This embodiment is an example of a configuration in which the method of the present invention is applied to a memory test pattern generator circuit.

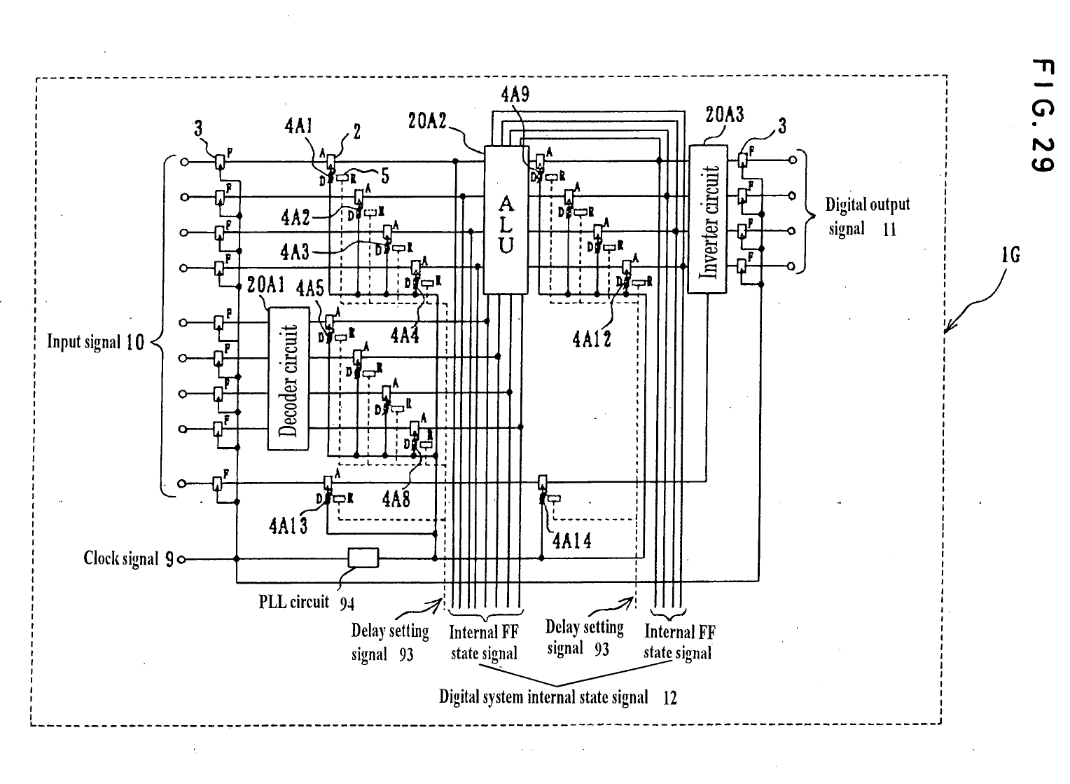

FIG. 29 is a schematic diagram showing a second embodiment of the digital system of the present invention in the form of a memory test pattern generator circuit 1G, the basic function of which is to generate a memory test pattern and which corresponds to the digital system 1 portion of FIG. 1, with the other apparatuses used being the same as those of FIG. 1.

Here, the adjustment apparatus 6, digital signal observation apparatus 7, digital test signal generation apparatus 8 and electric power supply apparatus 14 are external apparatuses. Also, circuits that are the same as those shown in FIG. 1 have been given the same symbols.

The flipflop 2 that is adjusted is an ordinary D flipflop and, similarly, the flipflop 3 that is not adjusted is an ordinary D flipflop. The clock line is directly connected to the clock terminal of the flipflop 3 that is not adjusted, but an adjustable delay element 4 is inserted between the clock terminal of the flipflop 2 that is adjusted and the clock line.

Connected to the adjustable delay element 4 is a register 5 that controls the delay time of the adjustable delay element 4. Here, if the register 5 is taken to be four bits, the adjustable delay element 4 can be configured as in FIG. 16.

Moreover, if the minimum delay time unit DT is taken to be 50 ps, in accordance with the register 5 values, an adjustable delay element 4 can generate a delay of 0 ps to 750 ps.

In cases in which the register 5 has a width of four bits, it is comprised of four ordinary D flipflops. A four-bit delay value setting signal and a four-bit common setting instruction signal are input to the register 5.

The delay setting signal (delay value setting line) 93 is a collection of all of the four-bit delay value setting signals and common setting signals of all of the registers. Also, digital system internal state signal 12 is the collected outputs of all of the flipflops 2 that are adjusted.

Decoder circuit 20A1 executes decode processing on signals that are input, and is configured as a combinational circuit (not including recording elements such as flipflops).

ALU circuit 20A2 is a combinational circuit that inputs four-bit input signals and four-bit arithmetic instruction signals of two systems, performs arithmetic between the input signals of the two systems in accordance with arithmetic instruction signals, and outputs the arithmetic result as four-bit output data.

Inverter circuit 20A3 is a combinational circuit having the function, in accordance with external instructions, of inverting input signals or performing non-inverted output.

PLL circuit 94 is connected between the input terminal of the clock signal 9 and the adjustable delay element 4 connected to the flipflop 2 that is adjusted, and generates a clock signal having the same frequency as that supplied to the flipflop 2 that is adjusted, with a timing that is advanced by 400 ps.

As described in the foregoing, the adjustable delay element 4 can generate a delay of from 0 ps to 750 ps, so combined together they can generate a delay of from −400 ps to 350 ps, that is, can supply each of the flipflops 2 that are adjusted with a clock that is from a state in which it is advanced by 400 ps till a state in which it is delayed by 350 ps.

Therefore in this case, the clock timing of the flipflop 2 that is adjusted is also changed from −400 ps to 350 ps depending on the value set in the register 5. When, for example, 1011 has been set in the register 5, the clock timing of the corresponding flipflop 2 that is adjusted will be delayed 150 ps with respect to the externally supplied clock signal 9.

Clock signal 9 is supplied directly to the clock terminal of the flipflop 3 that is not adjusted, and the flipflop 3 that is not adjusted operates at the same timing as the clock signal 9.

The circuit of this embodiment is not a simple pipeline structure; inputs on one side of the ALU circuit 20A2 are fed back on each side of the flipflop 2 that is adjusted.

In this embodiment, all of the flipflops connected to the outside terminal of the digital system 1 are flipflops 3 that are not adjusted and the others are flip-flops 2 that are adjusted, but the present invention does not have to be like this.

Similarly, also, the digital system internal state signal 12 is constituted just of outputs of the flipflops 2 that are adjusted, but this too is not essential.

Even if the characteristic values of each of the elements that appear in this embodiment are not always precise, the system of the present invention is applicable and effective.

This embodiment is particularly suited to application to memory test pattern generator circuits used to test high-speed memory devices.

Furthermore, the circuit covered in this embodiment has a four-bit output, so the present invention is particularly suitable in the case of memory test pattern generator circuits that output a larger number of bits, which increases the number of adjustment locations in addition to which the delay time dependency relationships between flipflops become complicated and a combinatorial explosion can readily occur.

Below, the adjustment method of the second embodiment to which the memory test pattern generator circuit 1G of this embodiment shown in FIG. 29 is described.

The performance of the memory test pattern generator circuit 1G can be represented by an evaluation function F which takes as arguments the delay values of the plurality of adjustable delay elements 4A1˜4A14. To have the memory test pattern generator circuit 1G operate without error is equivalent to finding the delay values that optimize the evaluation function F.

In this embodiment, there are 14 adjustable delay elements 4 (4A1˜4A14), which is a high number, so this is a case in which it is conceivable that a combinatorial explosion could occur, so the adjustment apparatus 6 changes the values of the register 5 according to the genetic algorithm, using the evaluation function F.

The adjustment of the adjustable delay elements 4, similarly to the case of the first embodiment, is performed in accordance with the flowcharts shown in FIG. 19 and FIG. 22. A major characteristic of this embodiment is that the register values of the register 5 are used directly as the chromosomes of the genetic algorithm. This eliminates the need for any processing or the like to convert the chromosome information to register values.

That is, as shown in FIG. 23, the chromosomes in this embodiment are comprised of the register values of 14 registers 5 corresponding to 14 delay elements. The registers 5 corresponding to the element parameters are each four bits. Thus the register length (=chromosome length) is 56 bits. Therefore the size of the adjustment search space for the memory test pattern generator circuit 1G of the above embodiment is 2ˆ56≈10ˆ17 (10 to the 17th power), so needless to say, adjustment using a full search is impossible.

In the adjustable delay element 4 shown in FIG. 16, this embodiment uses a DT value of 50 ps. This value is set according to the variation in the clock timing. For example, with the register values 1011 shown in FIG. 23, switch circuit Sw4, Sw2 and Sw1 is ON, connecting delay elements UD4, UD2 and Ud1 to the clock signal line, and as a result, the delay value corresponding to the register values 1011 will be 8×50+2×50−400=150 ps.

In the same way, the delay corresponding to register values 0101 will be 4×50+50−400=−150 ps, and the delay corresponding to register values 0001 will be −350 ps.

As the evaluation function F for individuals in the genetic algorithm used in the process of FIG. 22, a function that expresses how close the output measured by the digital signal observation apparatus 7 is to the expected value is used and operated after the memory test pattern generator circuit 1G is set with the register values that represent the chromosomes of the individuals. Specifically, the value calculated by the following evaluation function F is used as the fitness of the genetic algorithm.
fitness=F=NC/NT (Equation 1)

Here, NT is the number of outputs of the memory test pattern generator circuit 1G with respect to the test signal 10 series, and NC is the number of times, among the outputs of the memory test pattern generator circuit, that the expected digital value was output. The above evaluation function F takes a real-number value of 0 to 1, and taking the value 1 constitutes that the memory test pattern generator circuit 1G subject to adjustment has operated without error. For example, if among the output series of the digital system 1 set in register values representing a certain chromosome, the NC was 253 and the NT was 500, in that case the evaluation function F will be 0.506.

In order to be used in the process shown in FIG. 22, a plurality of individuals is first prepared using uniformly random numbers as the initial population of the genetic algorithm in Step S1 of FIG. 19. That is, in this case, this means that the value of each gene of each chromosome in the initial population takes a value of 1 at a probability of 0.5, and a value of 0 at a probability of 0.5. In this embodiment, the number of individuals in the population was set at 50.

After doing that, the memory test pattern generator circuit 1G is operated at the register values representing each individual and, using the results measured by the observation apparatus 5 in Step S3, in Step S4 the adjustment apparatus 6 calculates the fitness from the above evaluation function. Following that, in order, in Step S21 selection, in Step S22 crossover, and in Step S23 mutation processing is performed, creating the next-generation population of individuals (population of candidate solutions). In this embodiment, a crossover rate of 0.5 was used, which is the ratio of the number of individuals performing crossover out of the total number of individuals, and a mutation rate of 0.0125 was used.

In Step S4, it is determined whether or not the memory test pattern generator circuit 1G operates without error, and when operation is without error, non-defective processing is performed and the adjustment processing ends. When chromosomes (register values) that satisfy the specifications cannot be obtained even after the adjustment processing is repeated a set number of generations, the memory test pattern generator circuit 1G subject to the adjustment is determined to be defective, and in Step S8 is processed as defective. In this embodiment, the number of generations the that is repeated was set at 20.

Below are presented experimental results with respect to a case in which the adjustment method was applied to the memory test pattern generator circuit 1G shown in FIG. 29, using the genetic algorithm of this embodiment. In this experiment, a circuit was fabricated with an LSI chip, using CMOS technology.

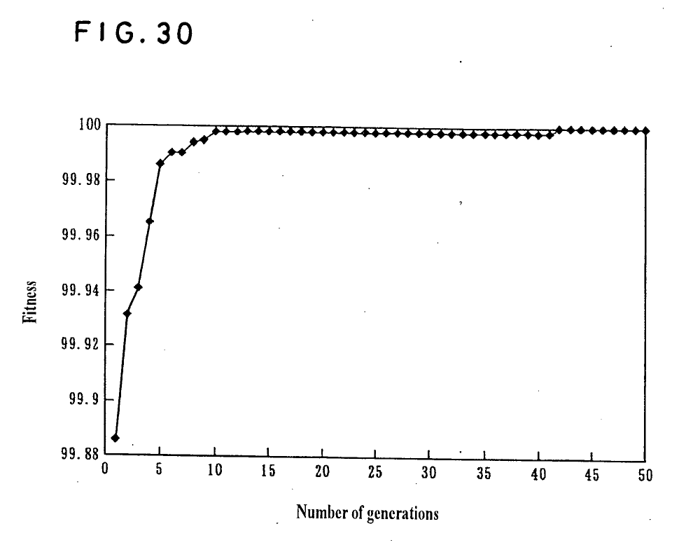

The results of the above experiment were that it was confirmed that when at clock frequencies of 1.0 Ghz, 1.25 Ghz, and 1.4 Ghz, the supply voltage was reduced 0.8 V from the specification 1.2 V, an LSI chip that malfunctioned when it was not adjusted operated without error when adjusted by the method using an genetic algorithm. FIG. 30 shows the relationship between the value of the evaluation function F of the best individuals during the generations of the experiment constituting fitness (a value relating to certain attempts) and number of generations (in the figure, the vertical axis shows 100 times the fitness value). It can be seen that as the genetic algorithm generation advances, the fitness value rises and the timing is adjusted. This experiment confirmed the efficacy of the adjustment method of this embodiment.

Moreover, in this embodiment a memory test pattern generator circuit was implemented on an ordinary integrated circuit, but it can be implemented using a reconfigurable integrated circuit such as an FPGA or CPLD or the like. In that case, a delay adjustment element can be implemented as part of an ordinary logic circuit, or can be implemented by developing and using a reconfigurable integrated circuit such as an FPGA or CPLD or the like in which the delay adjustment element is built in.

As described in the foregoing, in the memory test pattern generator circuit 1G of this embodiment, delay elements 4A1˜4A14 are inserted into the clock signal line to the flipflop elements, and a search is made for the delay times of the delay elements 3 that will make the memory test pattern generator circuit 1G operate without error even in a state in which the supply voltage is lowered from the specification (normal) voltage. Therefore, in accordance with this embodiment, adjustment is possible whereby deviations in clock timing and the like caused by design error or non-uniformity in clock signal line quality in the integrated circuit manufacturing process, as well as reductions in the operating speed of the logic elements in the circuit based on the reduced supply voltage, can be absorbed, so that the memory test pattern generator circuit 1G operates without error, and this means that, using less design labor than in the case of the conventional technology, it is possible to obtain digital systems that are faster and consume less electric power than in the case of the conventional technology.

At the same time, also, in accordance with this embodiment, adjustment is possible whereby deviations in clock timing and the like caused by design error or non-uniformity in clock signal line quality in the integrated circuit manufacturing process can be absorbed by slightly raising the supply voltage so that the memory test pattern generator circuit 1G operates without error, and this means that, using less design labor than in the case of the conventional technology, it is possible to obtain digital systems that are faster and with a higher operating yield than in the case of the conventional technology.

The following modified example can be implemented with respect to this embodiment.

Other than the output of the digital signal observation apparatus 7 when performing adjustment of the memory test pattern generator circuit 1G, the amount of electric current consumption and the amount of heat generated by the memory test pattern generator circuit 1G can be measured and incorporated in the evaluation function. Generally the amount of heat generated and electric current consumed by an LSI fluctuates depending on the clock timing of inputs to the flipflops inside the LSI, so doing this makes it possible to respond to diverse specification requirements and improve the adjustment precision.

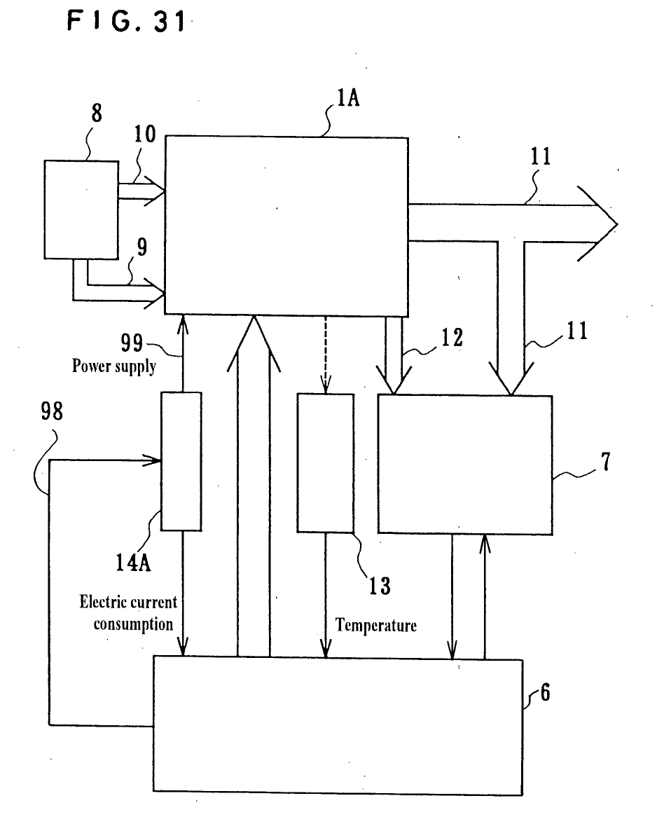

FIG. 31 shows an example of a configuration in the above case. In FIG. 31, symbol 13 is a thermometer and 14 a power supply. In FIG. 31, parts that are the same as those in FIG. 1 have been given the same symbols. Here, the thermometer 13 measures the temperature of the memory test pattern generator circuit 1G LSI, and that value is subjected to A/D conversion and passed to the adjustment apparatus 6. The electric power supply apparatus 14A is an apparatus that performs power supply 99 to the memory test pattern generator circuit 1G; the electric current supply value is subjected to A/D conversion and passed to the adjustment apparatus 6. While digital test signal generation apparatus 8 is outputting test signal 10, the adjustment apparatus 6 monitors the temperature and the amount of electric current consumption, and calculates the average temperature and average amount of electric current consumption during that time, and also gives the power supply control signal 98 to the electric power supply apparatus 14A.

In this modified example, for example, the following kind of evaluation function can be used.
fitness=NC/NT (when NC/NT<1)
fitness=1+1/(1.0+w1|T−Tm|+w2|I−Im|) (when NC/NT=1) (Equation 1)

Here, fitness is fitness in the genetic algorithm, T is measured average temperature, I is measured average electric current consumption, Tm is ideal average temperature, Im is ideal average electric current consumption, and w1, w2 are weighted coefficients. With this evaluation function, adjustment is performed until the memory test pattern generator circuit 1G operates without error; after there is no operation error, further adjustment is performed to bring the average electric current consumption and average temperature closer to the ideal values.

After that, as in the previous embodiment, adjustment is performed to reduce the supply voltage, within the range in which the memory test pattern generator circuit 1G does not malfunction.

Moreover, in this invention, peak values during measurement of the electric current consumption may be incorporated into the above evaluation function to further improve the adjustment precision.

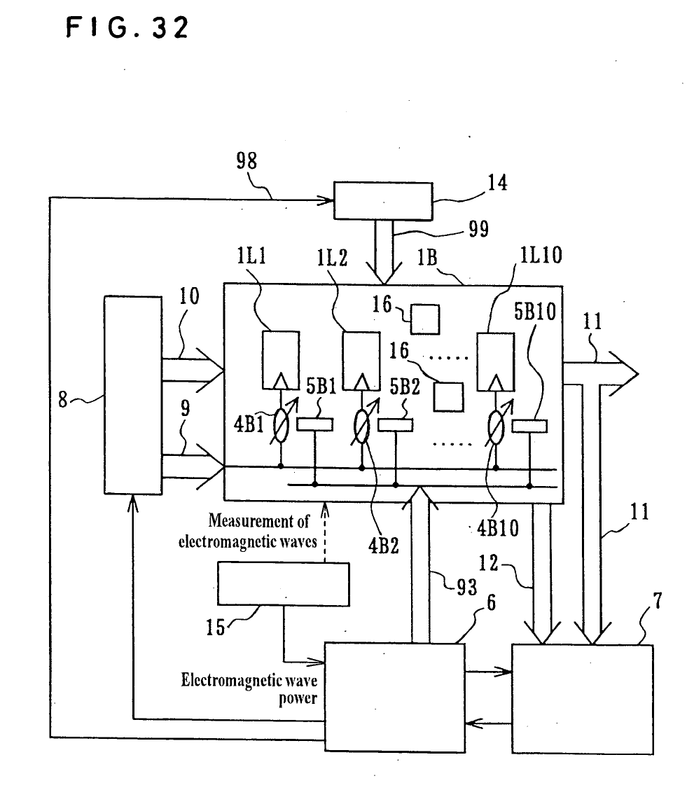

Next, an example of a configuration of digital circuit board is shown as a third embodiment of the digital system of this invention. FIG. 32 shows the configuration of the digital circuit board of this third embodiment. In FIG. 32, 1B is a digital circuit board. In place of the digital system 1 of the first embodiment, the system of this embodiment is configured using the digital circuit board 1B, which provides basic functions similar to those of the digital system 1. Constituent elements that are the same as those shown in FIG. 1 have been given the same symbols.

A plurality of LSIs 1L1˜1L10 to which clock signal 9 is input and electronic components 16 to which the clock signal is not input are implemented within the digital circuit board 1B. Also, these LSIs and electronic components are connected together by a data line that is not shown. 4B1˜4B10 are adjustable-delay-time delay elements, the delay time of each of which is adjusted according to a corresponding value shown in registers 5B1˜5B10. In this embodiment, there are 10 measurement locations. Also, symbol 15 is an electromagnetic wave measurement apparatus that is an external apparatus.

In digital circuit boards, there are LSIs that produce malfunction arising from impedance mismatches and floating capacitance and the like within the clock line on the board that cause the timing of clock signal inputs to the LSIs 1L1˜1L10 to become uneven, so that often the output 11 of the digital circuit board does not become the expected value. Moreover, in cases in which the digital circuit board is operated at a low supply voltage in order to keep down the power consumption, it slows the operating speed of the logic elements comprising the digital circuit board, making it difficult to maintain the correct timing.

This being the case, an effective countermeasure to malfunction is to adjust the timing of the clock signals to each LSI, but because the data signals of the LSIs 1L1˜1L10 have a relationship of mutual dependency, it is necessary to perform overall adjustment of the adjustment locations of the delay elements 4B1 to 4B10.

Also, in digital circuit boards, on the board there is a flow of digital signal current that includes high-harmonic components having high frequencies, so the power of electromagnetic noise emanating from the board is large. Therefore, as EMI noise, this has an effect on the human body and electronic apparatuses in the vicinity. This noise emission can reduce the peak power of LSIs by producing slight deviations in the timing of clocks input to the LSIs. The external effect of the above noise emission can be reduced by measuring the noise emission and adjusting the clock timing. In addition, driving a digital circuit board at a low supply voltage is an effective EMI countermeasure that makes it possible to reduce the total electromagnetic noise emanating from the board.

The above electromagnetic wave measurement apparatus 15 measures the electromagnetic wave power emanating from the board, subjects that value to A/D conversion and passes it to the adjustment apparatus 6. While digital test signal generation apparatus 8 is outputting a test signal, the adjustment apparatus 6 monitors electromagnetic wave power and calculates the average peak value during that time.

The third embodiment of the adjustment method of the present invention for adjusting the above digital circuit board 1B will now be explained. The adjustment method of this embodiment is basically the same as the adjustment method of the foregoing first embodiment.

After the digital circuit board 1B has been manufactured, in the inspection step, the adjustment apparatus 6, digital signal observation apparatus 7, digital test signal generation apparatus 8, electric power supply apparatus 14 and electromagnetic wave measurement apparatus 15 are each connected to the digital circuit board 1B, as shown in FIG. 32. The electric power supply apparatus 14 supplies the digital circuit board 1B. The digital test signal generation apparatus 8 inputs test signal 10 and clock signal 9 to the digital circuit board 1B. The digital signal observation apparatus 7 measures the value of the output of the digital circuit board 1B, the electromagnetic wave measurement apparatus 15 measures noise emanating from the digital circuit board 1B, and each is given to the adjustment apparatus 6, and the adjustment apparatus 6 performs evaluation using, for example, the following evaluation function.
fitness=NC/NT (when NC/NT<1)
fitness=1+1/(1.0+|P|) (when NC/NT=1) (Equation 3)

Here, fitness is fitness in the genetic algorithm, and P is measured electromagnetic peak power. With this evaluation function, adjustment is performed until the digital circuit board 1B operates without error; after there is no operation error, further adjustment is performed to reduce the peak power value of the noise emission. Alternatively, in addition to the supply voltage the electric power supply apparatus 14 supplies to the digital circuit board 1B as an evaluation function, it is also possible to perform control to effect operation at as low a supply voltage as possible and also reduce electromagnetic wave peak power P. In this case, first taking the supply voltage into consideration, after setting the output of the electric power supply apparatus 14 at the lowest supply voltage at which the digital circuit board 1B operates, adjustment can be performed to reduce the electromagnetic wave peak power P based on the above [Equation 3] evaluation function, or adjustment can be performed taking P as the electromagnetic wave peak power and the weighted average of the supply voltages output by the electric power supply apparatus 14.

As in the case of the method of the first embodiment, there is a one-to-one correspondence here between the chromosomes and the register values. That is, as shown in FIG. 23, the chromosomes in this embodiment are comprised of the register values of 10 registers 5 corresponding to 10 adjustment locations. The registers 5 corresponding to the adjustment locations are each four bits, so the chromosome length is 40 bits. Therefore the size of the adjustment search space for the digital circuit board 1B of the above embodiment is 2ˆ40≈10ˆ12 (10 to the 12th power), so needless to say, adjustment using a full search is impossible.

In accordance with the method of this embodiment, a plurality of adjustable-delay-time delay elements 4B1˜4B10 is used on the clock signal 9 within the digital circuit board 1B, and the delay values thereof are adjusted so that there is no malfunction of the digital circuit board 1B output. Thus, adjustment is possible whereby deviations in clock timing and the like caused by design error or non-uniformity in the clock signal line process in the digital circuit board manufacturing process can be absorbed, so that the digital circuit board 1B operates without error.

With this embodiment, also, adjustment can be performed that takes into account noise emanating from the digital circuit board 1B as electromagnetic waves, making it particularly suitable in cases in which there are people and other electronic apparatuses around the digital circuit board 1B.

In addition, in this embodiment 10 LSIs are implemented on the board, but in the present invention it goes without saying that the number of LSIs is not a problem. It also goes without saying that the value P of the above evaluation function need not be taken into consideration when the magnitude of noise emissions does not matter, such as in cases in which there are no people or other electronic apparatuses around the circuit board.

The method of this embodiment is particularly suitable in cases of high clock frequencies. That is because in cases of high clock frequencies, adjusting the timing of clock signals becomes more difficult, in addition to which the power of high-harmonic components of the electromagnetic noise emissions is greater.

The above-described first to third embodiments used genetic algorithms with respect to the handling of the initial settings of the registers 5 and the method of changing the register values from the initial settings. However, in cases in which the clock signal line has a tree structure, it is possible to use an algorithm called genetic programming in place of a genetic algorithm.

For details of genetic programming, see, for example, “Genetic Programming” by J. Koza, published by MIT Press in 1992. In genetic programming, genetic algorithms are devised to also handle tree structure chromosomes.

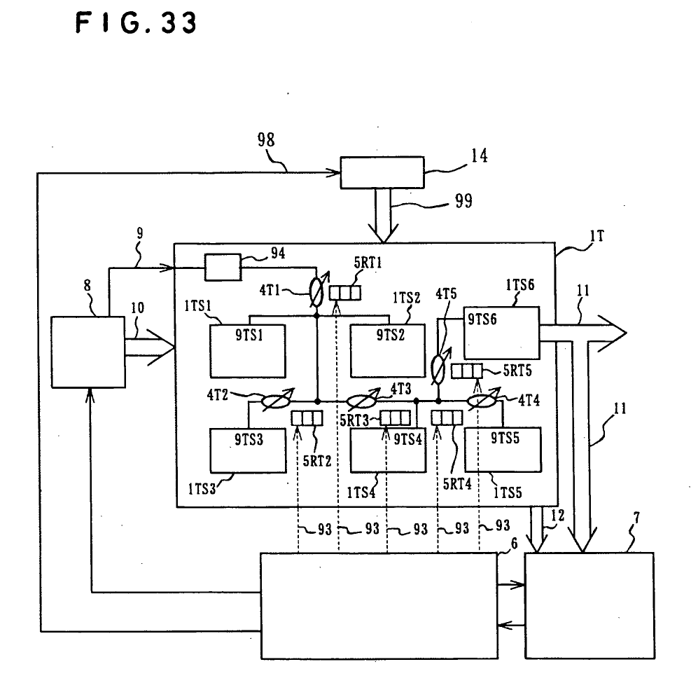

Next, a digital system and adjustment method according to a fourth embodiment of the present invention are described, having the system configuration shown in FIG. 33, in which the adjustment apparatus 6 changes the values of the registers 5 in accordance with this genetic programming. A major feature of this embodiment is that as the chromosomes of the genetic programming, the tree structure of the clock signal line can be mapped as-is to the chromosome structure of the genetic programming. Similarly to the case of the first embodiment, this eliminates the need for circuits and the like for converting chromosome information to register values.

The digital system 1T shown in FIG. 33 provides the same basic functions as the digital system 1, but in the digital system 1T, clock signal 9T is input to the digital system 1T, branched into a tree structure and input to digital subsystems 1TS1˜1TS6. In these digital subsystems, the above clock signal is provided as a clock signal to all of the flipflops. Delay elements 4T1˜4T5 are inserted into the branches of the clock signal line, and the delay value of each can be changed by a corresponding register value 5RT1˜5RT5. The digital subsystems are connected together by a data line that is not shown.

Next, the adjustment method of the fourth embodiment of the present invention that uses genetic programming is described. Like the first embodiment, this adjustment method follows the flowchart of FIG. 19. Also, the genetic programming processing sequence is the same as that shown in the flowchart of FIG. 22, with only the method of representing the chromosomes and the crossover method being different.

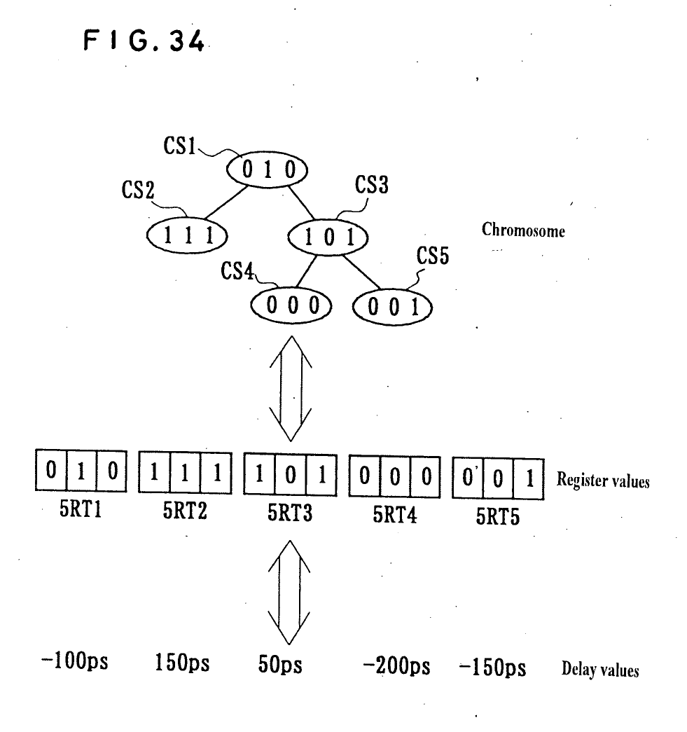

The tree structure shown in FIG. 34 is used for the genetic programming chromosomes. That is, the tree structure is used to represent the connective state of the clock signal line shown in FIG. 33 as-is, with the bit sequences of the chromosome nodes CS1˜CS5 corresponding to the values of registers 5RT1˜5RT5. In FIG. 34, the length of each register is described as 3, but it goes without saying that this adjustment method can be applied to any number of bits.

As the evaluation function F of the genetic programming individuals used in the processing of FIG. 22, a function is used that represents how close to the expected value the digital output measured by the digital signal observation apparatus 7 is, after the digital system 1T is set to the register values representing the individual chromosomes and operated.

In order to be used in the process shown in FIG. 22, a plurality of individuals is first prepared using uniformly random numbers as the initial population of the genetic algorithm in Step S1 of FIG. 19. That is, in this case, this means that the value of each gene of each chromosome in the initial population takes a value of 1 at a probability of 0.5, and a value of 0 at a probability of 0.5. However, in a case in which there exists some foreknowledge regarding the non-uniformity tendencies in the clock timing, it is possible to create individuals considered to have a higher fitness as the initial population.

Using the above evaluation function, the adjustment apparatus 6 calculates the fitness of each individual of the initial population from an evaluation value sent from the digital signal observation apparatus 7 (Step S3). Following that, in Step S4 it is determined whether or not the digital system 1T performance is operation without error, and if it is operating without error, the adjustment processing ends after the no-defect processing of Step S9.

If the no-defect processing of Step S9 cannot be effected with respect to all of the individuals of the initial population, the process proceeds to the genetic processing of Steps S21˜S30. If during the fitness calculation processing of Step S26 or Step S29 it is determined that the performance of the digital system 1T is operation without error, the adjustment processing ends after the no-defect processing of Step S9. If no chromosomes (register values) can be obtained that operate without error even after performing Steps S21˜S30 repeatedly for a fixed number of generations to make the adjustment process, the digital system 1T subject to adjustment is determined to be defective and it is processed as defective in Step S9.

In the genetic processing of the genetic programming, as in the case of the first embodiment, the method shown in the flowchart of FIG. 22 is used.

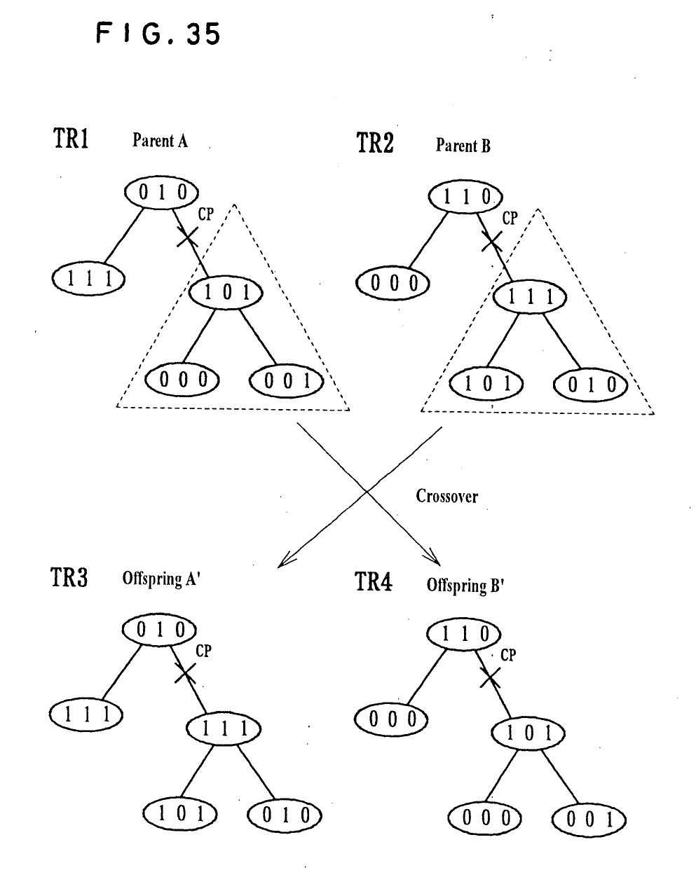

The method shown in the explanatory diagram of FIG. 35 is used for the crossover processing of Step S22. This is an operation wherein partial exchange of the chromosomes of the tree structure takes place at random positions, a characteristic operation in genetic programming. In FIG. 35, TR1 and TR2 are chromosomes of the parents A, B resulting from the selection process of Step S21. In this crossover process, these chromosomes are cut at a randomly selected crossing point CP. Then, by exchanging the cut partial genotypes, offspring A′, offspring B′ which have the chromosomes TR3 and TR4, respectively, are created. Using this method enables crossover to be performed without destroying the part of the chromosome information that is useful for searching.

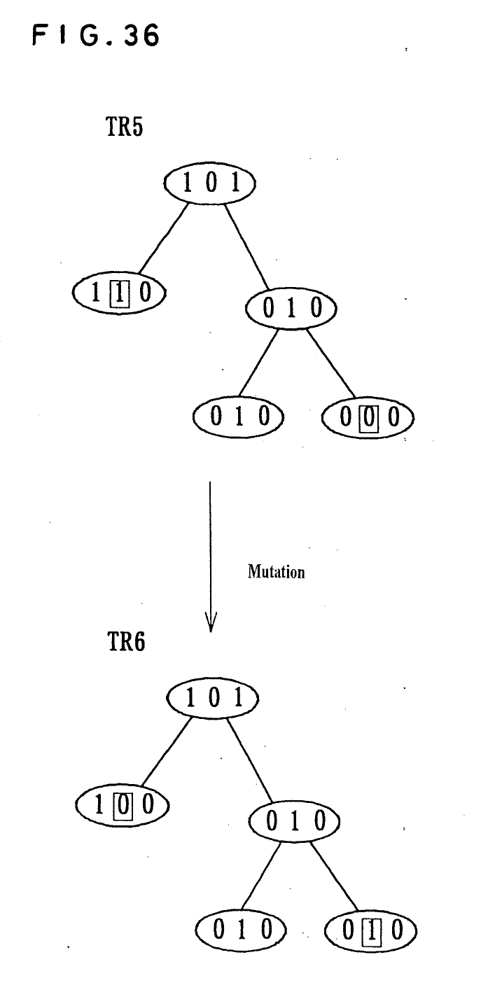

The mutation of Step S23 that is executed following the crossover of Step S22 is an operation that changes the gene bits of each chromosome from 0 to 1, or from 1 to 0, at the mutation rate occurrence probability. FIG. 36 shows a mutation example. In FIG. 36, mutation occurs in the genes of the chromosome TR5 shown enclosed in squares, which are each changed to alleles in the chromosome TR6.

In general genetic programming, in addition to crossover and mutation, genetic operations to insert and delete tree structures are also performed. However, those operations alter the length of chromosomes, so using those operations makes it impossible to convert the chromosome information directly to register values, which is why they are not used in this embodiment.

Using the above genetic programming in accordance with this embodiment makes it possible to adjust efficiently when the clock signal line has a tree structure.

It goes without saying that the present invention can be applied to all, to a part, or to a plurality of parts of an apparatus that uses the digital system, regardless of the size of the digital system.

Also, the adjustment according to the method of the present invention is almost unhindered by low precision of the adjustable delay elements 4 or lack of assurance of monotonicity. Therefore, the delay elements used in the present invention can be fabricated on a smaller area of a semiconductor substrate than before.

The foregoing description has been made based on the illustrated examples. However, this invention is not limited to the above examples, and includes modifications and other configurations that can readily be accomplished by someone skilled in the art, within the described scope of the claims.

### INDUSTRIAL APPLICABILITY

In a digital system 1 that carries out digital processing in accordance with a single or a plurality of digital clock signals to perform a prescribed basic function, the digital system is equipped with a plurality of delay elements 4 provided therein each comprising a circuit element that change a delay time according to a value indicated by a control signal, that are inserted in a plurality of clock circuits that supply the clock signals, and a plurality of holding circuits 5 that hold a plurality of control signals applied to the plurality of delay elements.

In a state in which the digital system 1 is supplied with power from a variable output voltage power supply apparatus 14, values of the plurality of control signals held by those holding circuits are changed by an external apparatus 6˜8 in accordance with a probabilistic search technique so that a basic function of the digital system satisfies prescribed specifications.

1. A digital system that carries out digital processing in accordance with a single or a plurality of digital clock signals to perform a prescribed basic function,
the digital system comprising
a plurality of delay elements provided therein each comprising a circuit element that changes a delay time according to a value indicated by a control signal and is inserted in each of a plurality of clock circuits that supply the clock signals, and
a plurality of holding circuits that hold a plurality of control signals applied to the plurality of delay elements,
characterized in that in a state in which the digital system is supplied with power from a variable output voltage power supply apparatus, values of the plurality of control signals held by the plurality of holding circuits are changed by an external apparatus in accordance with a probabilistic search technique so that a basic function of the digital system satisfies prescribed specifications.

2. The digital system described in claim 1, characterized in that values of control signals held in the holding circuits are sequentially changed by the external apparatus in accordance with a genetic algorithm in a search for optimal values that brings the digital system into a state where its basic function satisfies prescribed specifications.

3. The digital system described in claim 1, characterized in that values of control signals held in the holding circuits are sequentially changed by the external apparatus in accordance with genetic programming in a search for optimal values that brings the digital system into a state where its basic function satisfies prescribed specifications.

4. The digital system described in any of claims 1 to 3, characterized in that the change to the plurality of control signals by the external apparatus is performed while changing an output voltage of the power supply apparatus in steps.

5. The digital system described in any of claims 1 to 3, characterized in that the change to the plurality of control signals by the external apparatus is performed with an output voltage of the power supply apparatus in a state of being lower than a design value of the digital system.

6. A digital system that carries out digital processing in accordance with a single or a plurality of digital clock signals to perform a prescribed basic function,
characterized in that the digital system comprises
a plurality of delay elements provided therein, each comprising a circuit element that changes a delay time according to a value indicated by a control signal and is inserted in each of a plurality of clock circuits that supply the clock signals,
a plurality of holding circuits that hold a plurality of control signals applied to the plurality of delay elements,
setting means that in a state in which the digital system is supplied with power from a variable output voltage power supply apparatus, changes values of the plurality of control signals held by the plurality of holding circuits in accordance with a probabilistic search technique so that a basic function of the digital system satisfies prescribed specifications.

7. The digital system described in claim 6, characterized in that in accordance with a genetic algorithm the setting means sequentially changes values of control signals held in the holding circuits, searching for optimal control signal values that brings the digital system into a state where its basic function satisfies prescribed specifications.

8. The digital system described in claim 6, characterized in that in accordance with genetic programming the setting means sequentially changes values of control signals held in the holding circuits, searching for optimal control signal values that brings the digital system into a state where its basic function satisfies prescribed specifications.

9. The digital system described in any of claims 6 to 8, characterized in that the change to the plurality of control signals by the setting means is performed while changing an output voltage of the power supply apparatus in steps.

10. The digital system described in any of claims 6 to 8, characterized in that the change to the plurality of control signals by the setting means is performed with an output voltage of the power supply apparatus in a state of being lower than a design supply voltage value of the digital system.

11. The digital system described in any of claims 1 to 10, characterized in having the power supply apparatus.

12. The digital system described in any of claims 1 to 10, characterized in that the digital system is constituted as an integrated circuit.

13. The digital system described in any of claims 1 to 10, characterized in that the digital system is constituted as a circuit board.

14. A method of adjusting clock signal timing of a digital system that carries out digital processing in accordance with a single or a plurality of digital clock signals to perform a prescribed basic function, comprising:
inserting each of a plurality of delay elements into each of a plurality of clock circuits that supply the clock signals in the digital system,
constituting each of the plurality of delay elements by a circuit element that changes a delay time according to a value indicated by a control signal, and
holding a plurality of control signals applied to the plurality of delay elements in a plurality of holding circuits provided in the digital system, and
characterized in that in a state in which the digital system is supplied with power from a variable output voltage power supply apparatus, values of the plurality of control signals held by the plurality of holding circuits are changed by an external apparatus in accordance with a probabilistic search technique so that a basic function of the digital system satisfies prescribed specifications.

15. The method of adjusting clock signal timing of a digital system described in claim 14, characterized in that in accordance with a genetic algorithm the external apparatus sequentially changes values of control signals held in the holding circuits, searching for optimal control signal values that brings the digital system into a state where its basic function satisfies prescribed specifications.

16. The method of adjusting clock signal timing of a digital system described in claim 14, characterized in that in accordance with genetic programming the external apparatus sequentially changes values of control signals held in the holding circuits, searching for optimal control signal values that brings the digital system into a state where its basic function satisfies prescribed specifications.

17. The method of adjusting clock signal timing of a digital system described in any of claims 14 to 16, characterized in that the change to the plurality of control signals by the external apparatus is performed while changing an output voltage of the power supply apparatus in steps.

18. The method of adjusting clock signal timing of a digital system described in any of claims 14 to 16, characterized in that the change to the plurality of control signals by the external apparatus is performed with an output voltage of the power supply apparatus in a state of being lower than a design value of the digital system.

19. A method of adjusting clock signal timing of a digital system that carries out digital processing in accordance with a single or a plurality of digital clock signals to perform a prescribed basic function, comprising:
inserting each of a plurality of delay elements into a plurality of clock circuits that supply the clock signals in the digital system,
constituting each of the plurality of delay elements by a circuit element that changes a delay time according to a value indicated by a control signal, and
holding a plurality of control signals applied to the plurality of delay elements in a plurality of holding circuits provided in the digital system, and
characterized in that in a state in which the digital system is supplied with power from a variable output voltage power supply apparatus, values of the plurality of control signals held by the plurality of holding circuits are changed by a setting apparatus provided in the digital system in accordance with a probabilistic search technique so that a basic function of the digital system satisfies prescribed specifications.

20. The method of adjusting clock signal timing of a digital system described in claim 19, characterized in that in accordance with a genetic algorithm the setting means sequentially changes values of control signals held in the holding circuits, searching for optimal control signal values that brings the digital system into a state where its basic function satisfies prescribed specifications.

21. The method of adjusting clock signal timing of a digital system described in claim 19, characterized in that in accordance with genetic programming the setting means sequentially changes values of control signals held in the holding circuits, searching for optimal control signal values that brings the digital system into a state where its basic function satisfies prescribed specifications.

22. The method of adjusting clock signal timing of a digital system described in any of claims 19 to 21, characterized in that the change to the plurality of control signals by the setting means is performed while changing an output voltage of the power supply apparatus in steps.

23. The method of adjusting clock signal timing of a digital system described in any of claims 19 to 21, characterized in that the change to the plurality of control signals by the setting means is performed with an output voltage of the power supply apparatus in a state of being lower than a design supply voltage value of the digital system.

24. The method of adjusting clock signal timing of a digital system described in any of claims 19 to 23, characterized in that the power supply apparatus is provided in the digital system.

25. The method of adjusting clock signal timing of a digital system described in any of claims 14 to 24, characterized in that the digital system is constituted as an integrated circuit.

26. The method of adjusting clock signal timing of a digital system described in any of claims 14 to 24, characterized in that the digital system is constituted as a circuit board.

27. The method of adjusting clock signal timing of a digital system described in any of claims 14 to 18, characterized in that the external apparatus is equipped with a computer.

28. The method of adjusting clock signal timing of a digital system described in any of claims 19 to 23, characterized in that the setting means is equipped with a computer.

29. A recording medium recorded with a processing program executed by the computer in the method of adjusting clock signal timing of a digital system according to claim 27 or claim 28 for changing the values of the plurality of control signals held by the plurality of holding circuits in accordance with a probabilistic search technique so that the basic function of the digital system satisfies the prescribed specification.
